(19) United States
(12) Patent Application Publication
(10) Pub. No.: US 2007/0058167 A1
(43) Pub. Date: Mar. 15, 2007

(54) Smart Thin-Film Coatings and Smart Polarization Devices, Smart Ellipsometric Memory, and Smart Ellipsometers

(76) Inventors: A.R. M. Zaghloul, Pooler, GA (US); Mervat A. Zaghloul, Pooler, GA (US); Yasser A. Zaghloul, Pooler, GA (US)

Correspondence Address: YASSER A. ZAGHLOUL, 2926 OSPREY POINT CIRCLE, POOLER, GA, 31322, US

(21) Appl. No.: 11/530,023

(22) Filed: Sep. 7, 2006

Related U.S. Application Data
(60) Provisional application No. 60/596,236, filed on Sep. 9, 2005.

(51) Int. Cl. G01J 4/00

(52) U.S. Cl. 356/369

(57) ABSTRACT

A closed-form formula is provided which is used to: 1) design thin-film coatings and transmission-polarization devices for polarization applications: determine the substrate optical constant, and the optical constant and thickness of a film-substrate system and the angle of incidence of operation to perform as a pre-specified optical polarization device at pre-specified conditions., 2) design transmission ellipsometric memory for CD, DVD, and other similar applications, 3) do real-time dynamic characterization of film-substrate systems by transmission ellipsometry using any ellipsometer to measure one or two pairs of the two ellipsometric angles psi and del at one or two angles of incidence and at only one wavelength to determine the optical constants of the film-substrate system and its film thickness, 4) develop computer programs and hardware implementation of items 1-3.

### CROSS-REFERENCE TO RELATED APPLICATIONS

This is a non-provisional application claiming the priority of Provisional Application No. 60//596,236 filed on Sep. 9, 2005.

### FIELD OF INVENTION

The present invention relates to thin-film coatings and transmission-polarization devices, transmission ellipsometric memory, and real-time dynamic characterization of a film-substrate system by transmission ellipsometric measurements; and more particularly, to employing a closed-form formula for design and for data-reduction purposes.

### BACKGROUND OF THE INVENTION

Ellipsometry is an optical technique that is widely used to characterize film-substrate systems by measuring the two ellipsometric angles psi and del at a certain angle of incidence and a certain wavelength. There are many ellipsometric techniques to do the measurements, and new ones are being developed all the time. A mathematical model developed in the 19^{th} century is used to obtain the optical constants of the film and the substrate in addition to the film thickness. In that model, each measured pair of psi and del provides one complex equation that is equivalent to two real equations. The widespread methods to determine the optical constants and film thickness require a number of real equations equal to the number of unknowns to be determined. Therefore, five real equations are required to determine the optical constants and film thickness since each optical constant is a complex number which has a real and an imaginary component. That requires three pairs of the angles psi and del measured at either three different angles of incidence (Multiple-Angle-Of-Incidence Ellipsometry) or at three different wavelengths (Spectroscopic Ellipsometry.) Several numerical techniques exist today to obtain the required results from the multiple measurements. All take desperately needed time and computational power for dynamic real-time applications. Some require continued intervention by and interaction with a human operator as many of the programs provided by ellipsometer manufacturers today.

Algebraic solution to the ellipsometric equation governing the complex model of the film-substrate system to provide a closed-form formula to calculate optical constants of the film and substrate is a very difficult and involved task. Previous to this invention, no closed-form for the optical constants and film thickness of the system are ever derived. Some of the advantages of a closed-form formula over numerical methods are: 1) it does not require a close-to-unknown-solution starting value for the unknown, 2) it involves no repeated calculations, only one, 3) it does not ever diverge giving no solution, 4) it does not get trapped in a false solution, 5) it does not get trapped in a local incorrect solution, 6) it has no merit function to minimize, 7) it does not involve numerical calculations of the derivative of the function, 8) its speed does not depend on the topology of the function, 9) its speed does not depend on the choice of the merit function, 10) its speed does not depend on the choice of the starting solution, 11 ) it does not require any involvement of, or interaction with, the user.

Thin films are widely used in many applications including, but are not limited to, antireflection coatings and solar cells. Such applications utilize the intensity characteristics of the film-substrate system in transmission and reflection. It is directly related to the system's polarization performance. That link is not properly addressed in the literature and it opens the door to more useful and simpler designs.

Ellipsometric transmission memory is used to store and retrieve digital information using multiple-film deposited on a substrate: four films of four different materials and four different thicknesses in general. That involves difficult design and manufacturing procedures. That type of memory is used for CD and DVD. It can also be used for other applications.

### SUMMARY OF THE INVENTION

It is, therefore, an object of the present invention to provide a real-time dynamic method by providing an algebraically derived closed-form formula to calculate the optical constants of the systems, and then the film thickness. The provided closed-form formula gives the correct results in each and every case.

An object of the invention is to dynamically characterize in real-time the film-substrate system: determine the film and substrate optical constants and film thickness by direct substitution into a given closed-form formula using any ellipsometer to measure only one pair of the two ellipsometric angles psi and del at only one angle of incidence and at only one wavelength.

Another object of the invention is to design thin-film coatings and/or polarization optical devices to perform as prescribed: determine the optical constants of the system, film thickness, and angle of incidence for the coating/device to provide prespecified values of the two ellipsometric parameters psi and del at a specific wavelength of operation.

Another object of the invention is to design smart transmission ellipsometric memory for CD, DVD, and other applications: determine the film-substrate optical constants and film thicknesses representing the logic zero and logic one, or any other number system.

Another object of the present invention is to provide a software computer program and/or a smart device to do the same.

All objects are achieved through the use of a novel closed-form formula.

As the different objects of the present invention that are only presented as preferred embodiments to illustrate the invention are clearly understood by professionals in the field as a result of this patent, it is expected that the other applications of the closed-form formulae and their associated methods will be identified.

### DESCRIPTION OF DRAWINGS

1Angle of incidence-film thickness plane (φ₀-dplane), where Dφ₀is the film-thickness period contour. (a) Point 1 (A) is the image of point 2 (B). (b) CTC of film thickness d and its image, where d<D₀. It coincides with its own image. (c) Same as in (b), but for d>D₉₀. The image is a continuous contour. (d) Same as in (b), but for

D₀<d<D₉₀ . The image is a discontinuous contour at d=Dφ₀. It coincides with only the second part of the CTC itself.

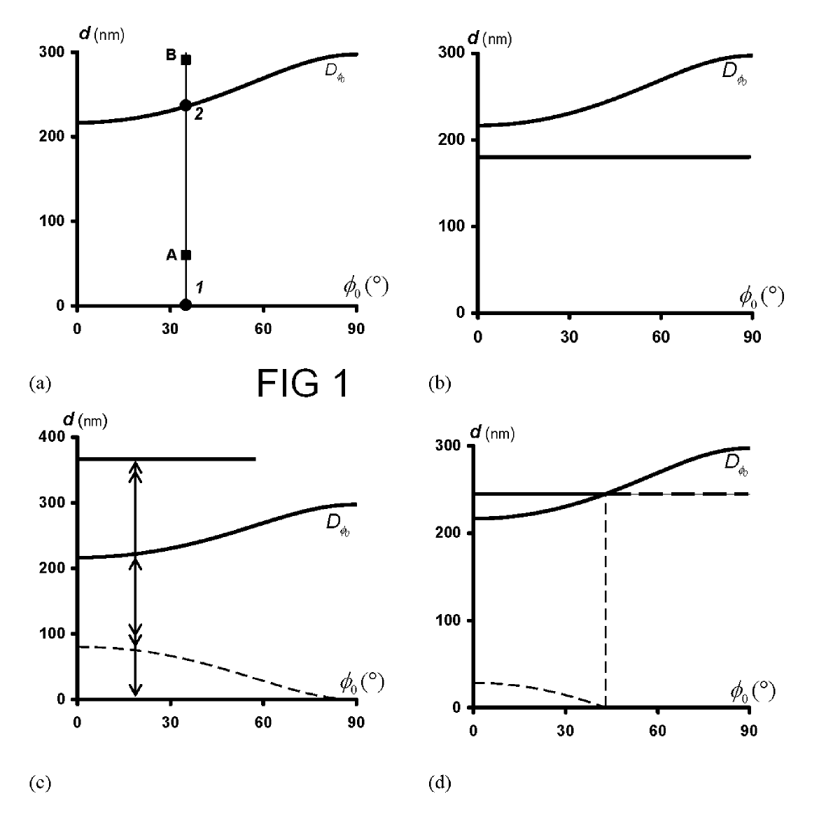

2. Constant-angle of incidence contours in the X-plane (XCAICs), for all angles of incidence. They all coincide with the unit circle, and rotate clockwise with the increase of the film thickness. Points 1 and 2 correspond to points 1 and 2 of FIG. 1.a. Point 3 is at d=D _{φ0}/2.

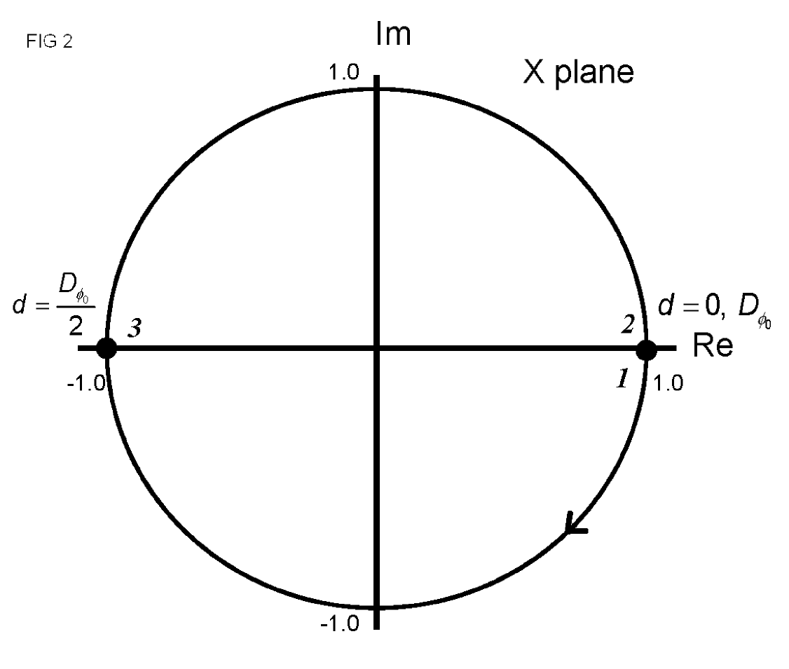

3. The inverse contour of the two points X±1 of FIG. 2.

4. (a) Mapping of points 1, 2, A, and B of FIG. 1.a, onto the X-plane. (b) Constant-thickness contour in the X-plane (XCTC) of film thickness dof FIG. 1.b. It rotates counter-clockwise as the angle of incidence is increased, starting at S and finishing at F. (c) Same as in (b), but for FIG. 1.c. (d) Same as in (b), but for FIG. 1.d.

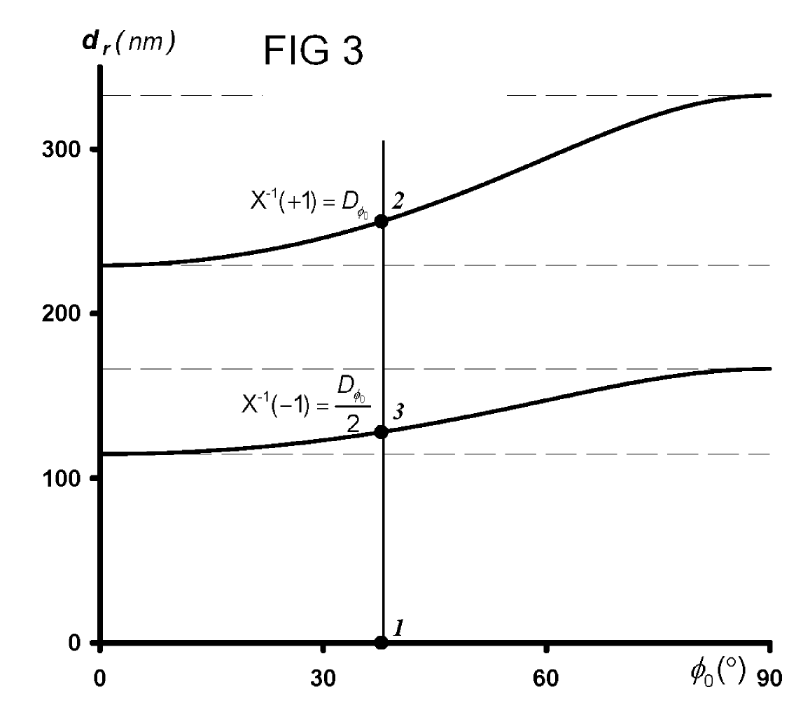

5. Start and finish points of each of the four subfamilies; SF1, SF2, SF3, and SF4. Note that SF2 intersects point X=−7, that SF4 intersects point X=+7, see FIG. 3.

6. Zero film-substrate system clockwise class of the constant-angle-of-incidence contours in the τ-plane (τCAIC) for different angles of incidence. Note points 1, 2, and 3, and the direction of rotation.

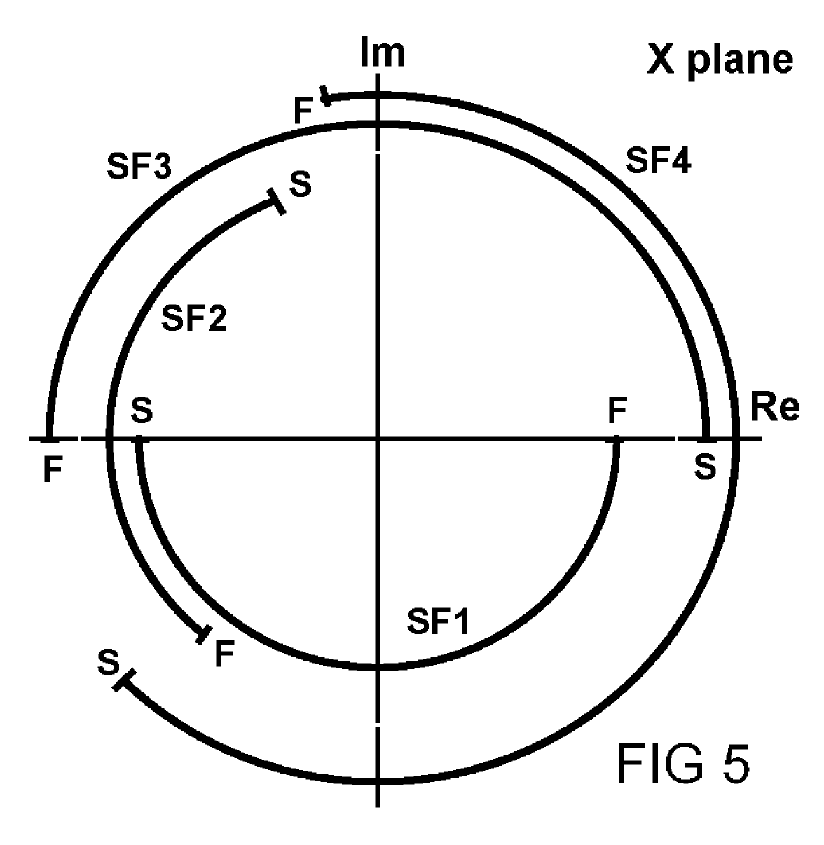

7. Subfamilies of the τCTCs, see also FIG. 5.(a) SF1. (b) SF2. (c) SF3. (d) SF4. The dotted parts are actually images of the first part of the contour, see FIG. 1.d.

8. A complete set of CTCs and CAICs in the τ- plane for the zero system.

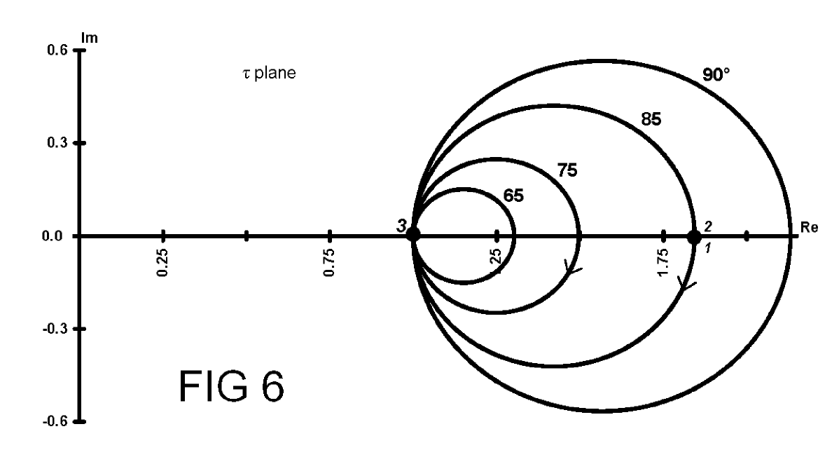

9. Same as in FIG. 6, but for the positive film-substrate system. Note the intersection of successive CAICs.

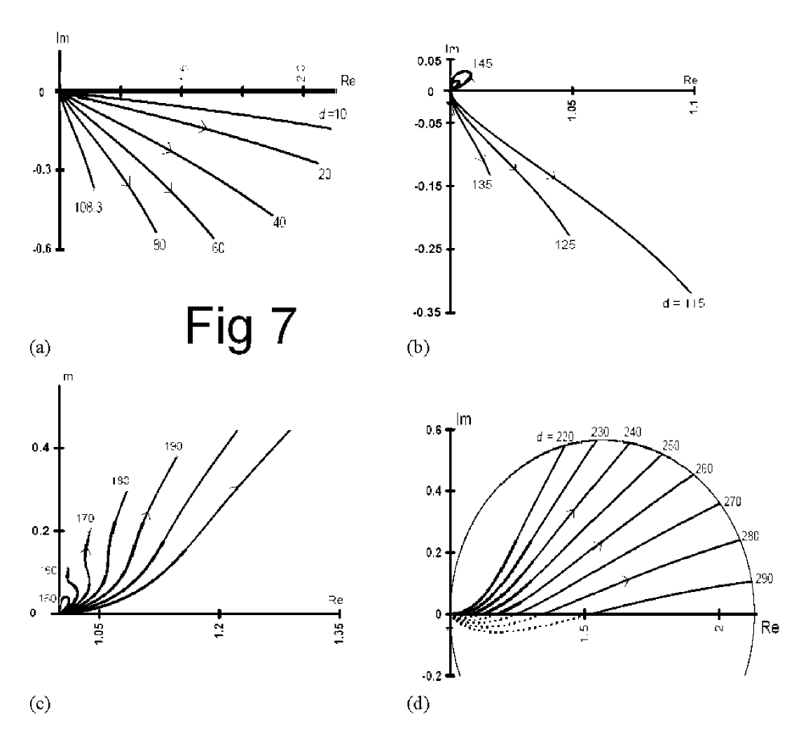

10. Same as in FIG. 7, but for the positive film-substrate system.

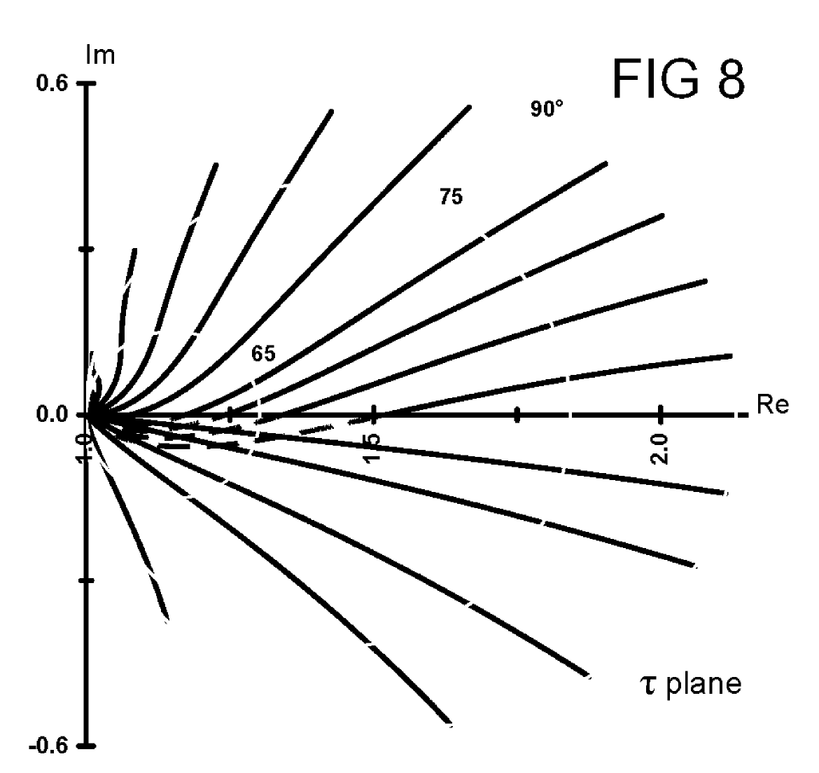

11. Same as in FIG. 8, but for the positive film-substrate system. Note the two-contour intersection outside of the τCAIC(90).

12. (a) Boundary value of the relative phase-shift of a zero-system polarization device as changed with the angle of incidence for different values of N₂, maintaining the zero-system condition.

(b) Same as in (a), but for the change with N2for different values of the angle of incidence.

13. (a) Upper and lower boundary value of the relative amplitude-attenuation of a zero-system polarization device as changed with the angle of incidence for different values of N₂, maintaining the zero-system condition. The lower boundary is constant at tan ψ=7.

(b) Same as in (a), but for the change with N2for different values of the angle of incidence.

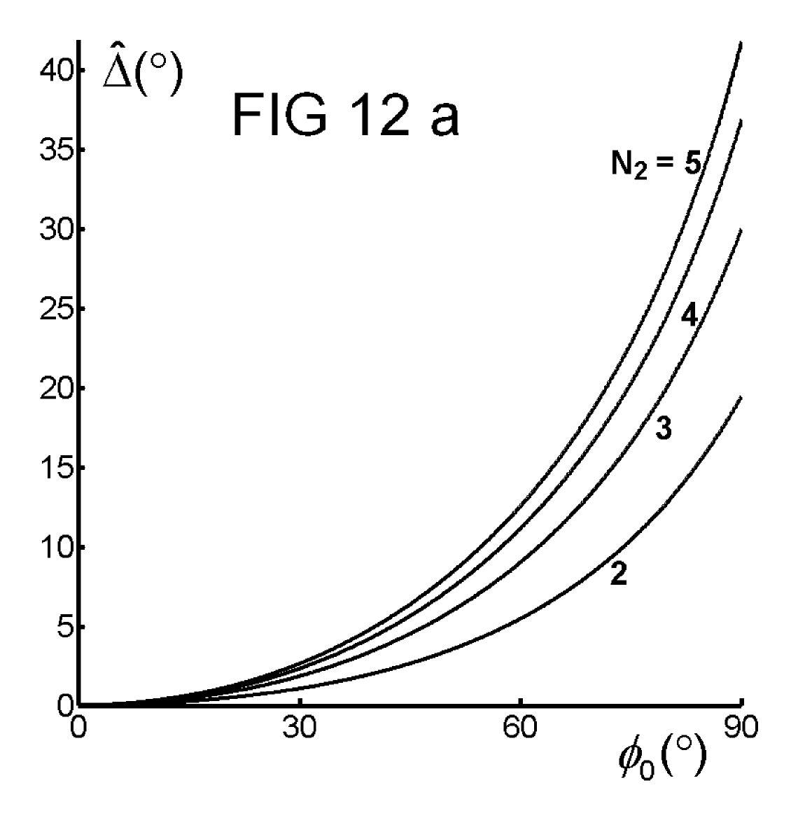

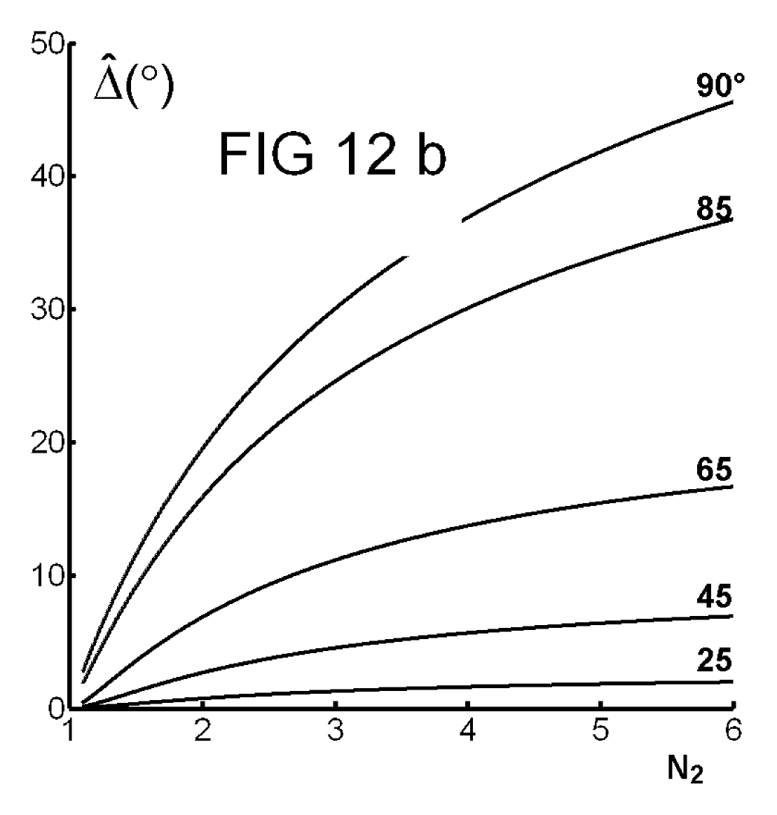

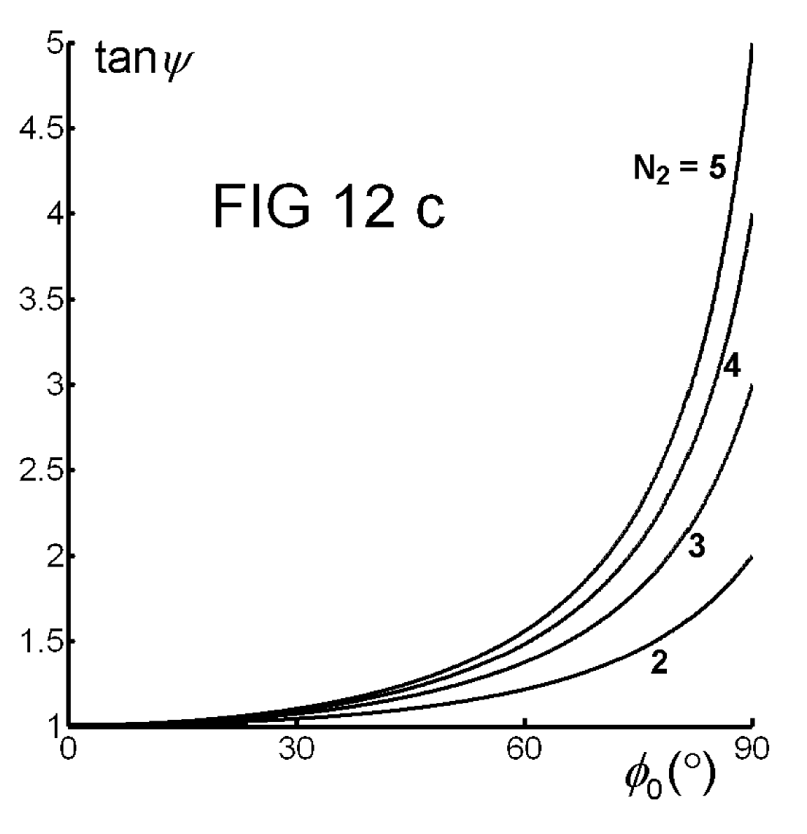

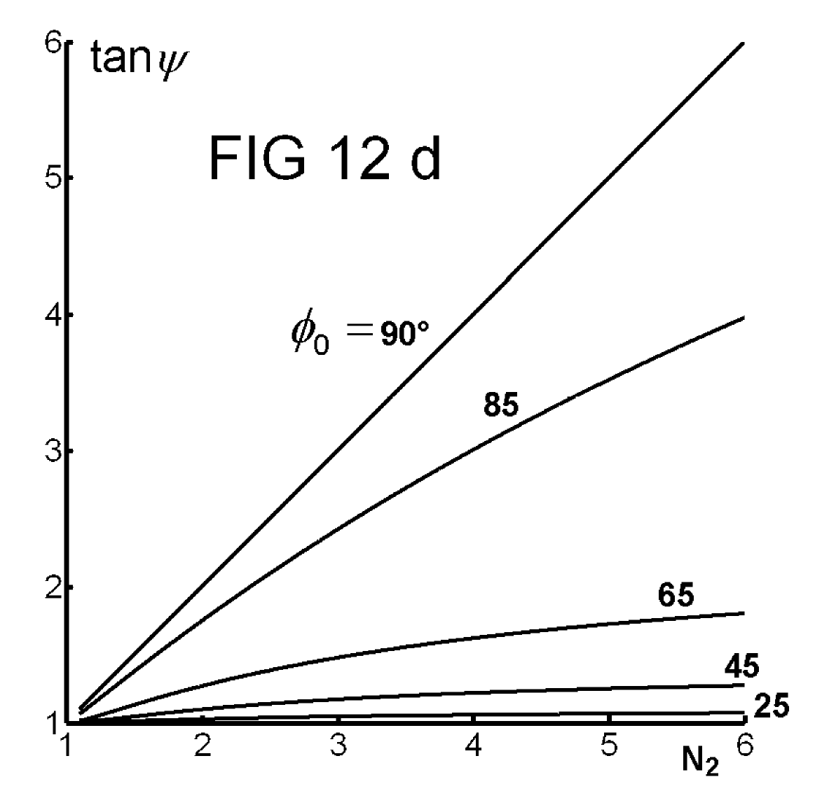

14. (a) Same as in FIG. 12.a, but for the positive system.

(b) Same as in FIG. 12.b, but for the positive system.

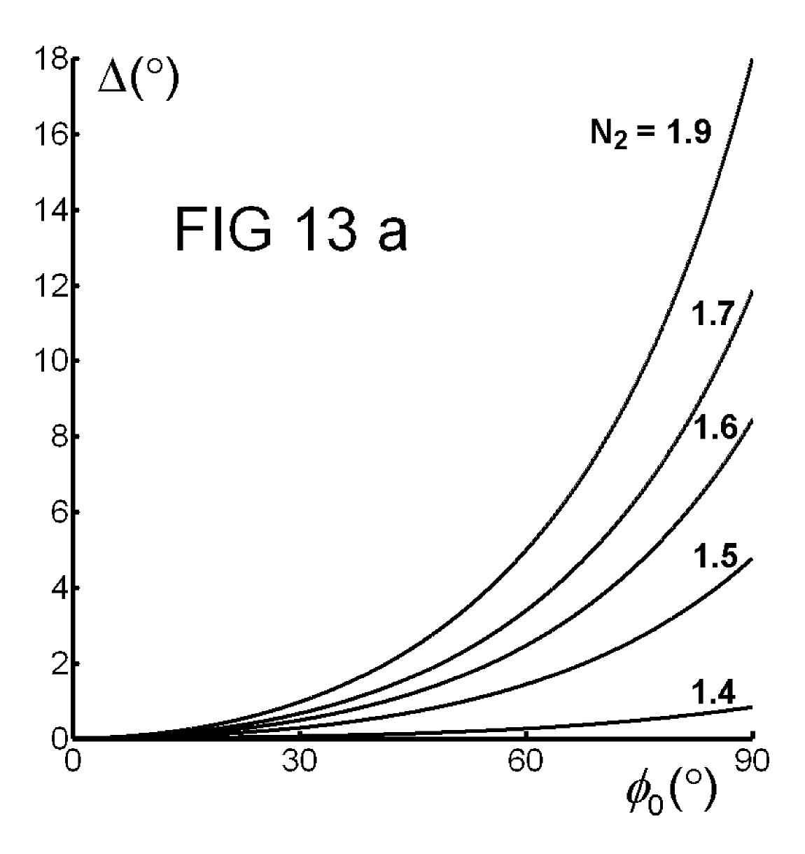

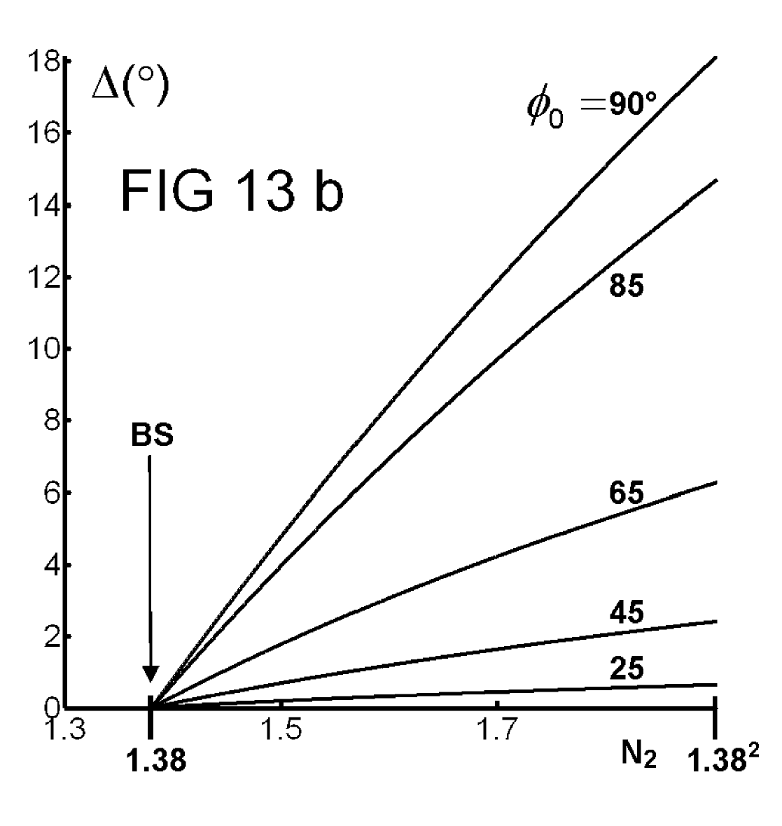

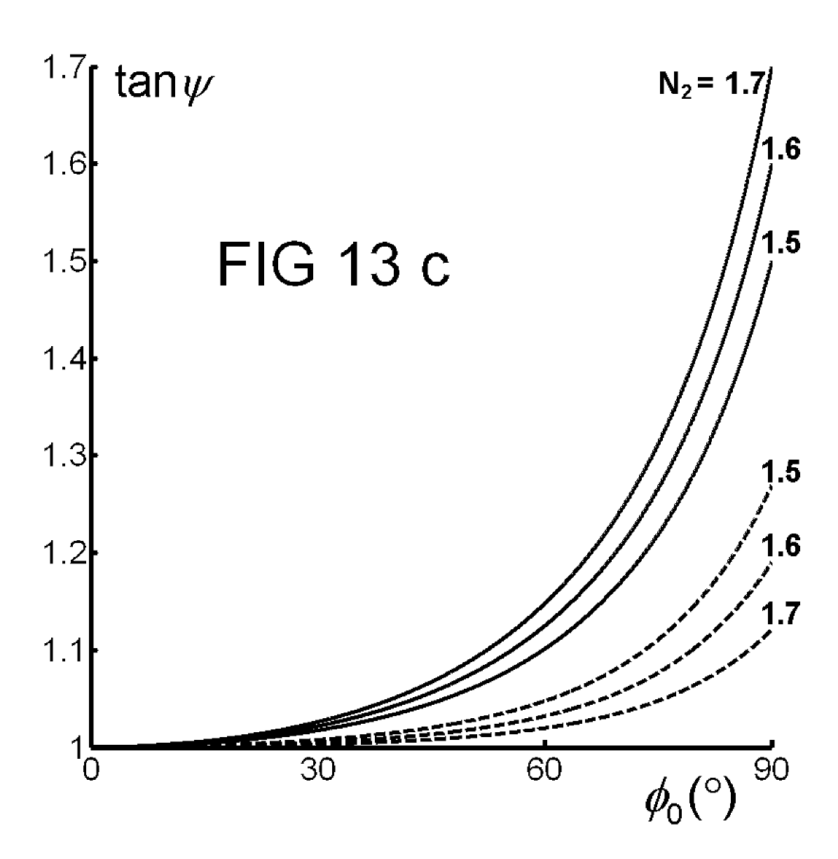

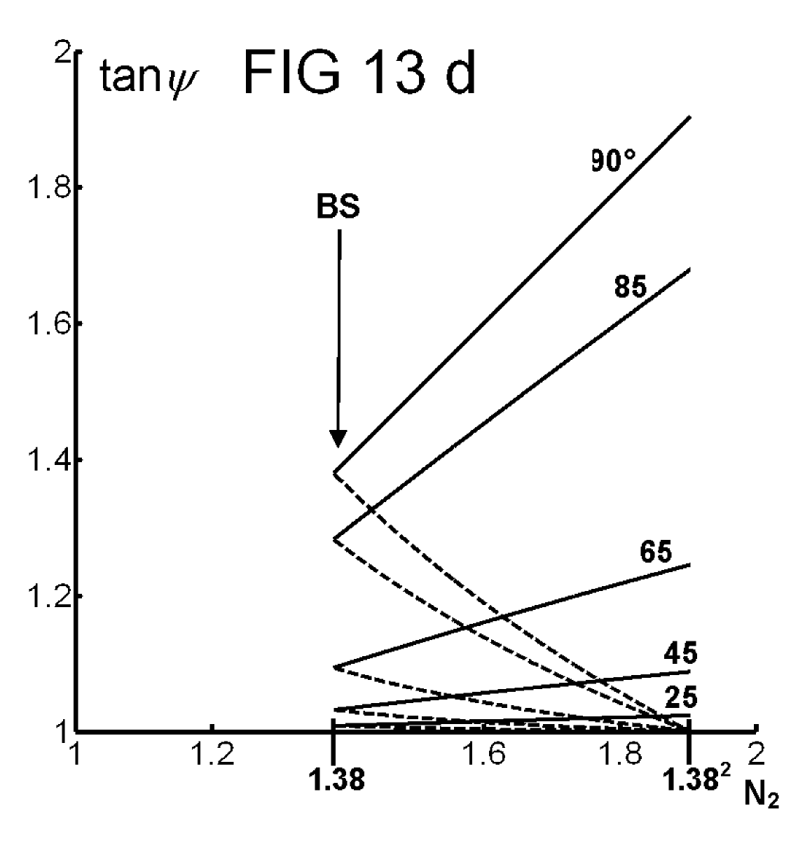

15. (a) Same as in FIG. 13.a, but for the positive system. Note that the lower boundary, dashed line, is not constant in this case.

(b) Same as in FIG. 13.b, but for the positive system. On the horizontal axis at 1.38, the system is a bare substrate. At 1.9044 (=1.38²), the system is a zero system.

### DETAILED DESCRIPTION OF THE INVENTION

Transparent coatings are used in numerous industrial applications and in research. They appear in biological systems and in polymers. They are applied in industrial applications as wide as beam steering and control, transistors, memories, antireflection, night vision, and laser amplification.

Polarization devices (PD) are used in many optical systems. For example, a train of three linear partial polarizers are used in front of the recording camera on the Hubble telescope to analyze the electromagnetic waves received. Optical components are used in laser manufacturing to reflect/transmit the electromagnetic wave as part of the lasing mechanism. The designs of those components are crucial, especially for high power lasers. Anti-reflection coatings are of great importance in military and civilian applications. The optical and thin film industries are two of the fast growing and economically important industries.

We use an ellipsometric function approach to thin film coatings and transmission polarization-device design. We focus on the three transparent film-substrate systems; negative, zero, and positive systems, where film-substrate systems are classified into three categories. The classification is based on the sign of N₁−√N₀N₂, where N₀, N₁, and N₂are the refractive indices of the ambient, film, and substrate respectively, assuming a three-phase system. The negative system is where the sign is negative, the zero system is where N₁=√N₀N₂, and the positive system is where the sign is positive. The three categories have distinctively different polarization characteristics.

The behavior of each studied system, zero and positive first then negative, is explained through the constant-angle-of-incidence contours (CAICs) and the constant-thickness contours (CTCs). These contours are obtained through keeping one of the two system's parameters constant; the angle of incidence or film thickness, respectively. The analysis of that behavior reveals the points of interest of the system that lead to proper applications.

The transmission ellipsometric function is discussed in the previous literature as one entity of only one behavior with no discussion of the presence of different behaviors for different types of film-substrate systems, of the presence of different behaviors for different subfamilies, and of the presence of two different classes of the system, as discussed in the following sections.

We focus on the polarization-device design of all existing types, depending on the system. We introduce closed-form formulae for those designs and provide limits of existence for each device, for each system under consideration.

We discuss two example-systems, keeping in mind that they represent two categories and not just two specific systems. For the zero system, we use 1, 1.46, and 2.1316 for N₀, N₁, and N₂, respectively. For the positive system we use 1, 1.38, and 1.5, respectively. All optical constants are at the widely used He-Ne laser wavelength of 632.8 nm. All film thicknesses are in nm, throughout. For the negative system, we use 1/1.36/3.85 at 632.8 nm.

The substrate considerations are then briefly discussed before we present a brief discussion of an interesting application of the design methodology and closed-form formulae to modify and improve on the transparent transmission ellipsometric memory for CDs and DVDs.

No derivations for any of the presented closed-form design formulae are given. They are derived through successive transformations, analytic geometry, and algebra.

The general formulae presented apply equally to the negative film-substrate system, and to transmission ellipsometry .

It is clear that the unsupported-film system, pellicle, is a special case of the film-substrate system discussed in this communication, where the film thickness is zero. Same formulas are to be used with substituting d=0.

Tranmission Ellipsometric Function (TEF)τ

The transmission ellipsometric function (TEF)τ of a film-substrate system that governs the polarization change of an electromagnetic wave obliquely incident on, and transmitted through, a film-substrate system is given by;

$$\begin{matrix}τ = \frac{{τ}_{p}}{{τ}_{s}} , & ( 1 ) \\ {τ}_{v} = \frac{{t}_{01 v} {t}_{12 v} {ⅇ}^{- jβ}}{1 + {r}_{01 v} {r}_{12 v} {ⅇ}^{- j2β}} , v = p , s . & ( 2 )\end{matrix}$$

p and s are the parallel and perpendicular components, of the wave electric vector, to the plane of incidence. Therefore, by direct substitution, Eq. (1 ) is written in the form;

$$\begin{matrix}τ = \frac{1}{A} \frac{1 + BX}{1 + CX} , & ( 3 ) \\ X = {ⅇ}^{- j4 π ( \frac{d}{λ} ) \sqrt{{N}_{1}^{2} - {N}_{0}^{2} {sin}^{2} {ϕ}_{0}}} , & ( 4 ) \\ ( A , B , C ) = ( \frac{{t}_{01 s} {t}_{12 s}}{{t}_{01 p} {t}_{12 p}} , {r}_{01 s} , {r}_{12 s} , {r}_{01 p} {r}_{12 p} ) , & ( 5. a ) \\ ( {t}_{01 p} , {t}_{01 s} ) = ( \frac{2 {N}_{0} cos {ϕ}_{0}}{{N}_{1} cos {ϕ}_{0} + {N}_{0} cos {ϕ}_{1}} , \frac{2 {N}_{0} cos {ϕ}_{0}}{{N}_{0} cos {ϕ}_{0} + {N}_{1} cos {ϕ}_{1}} ) , & ( 5. b ) \\ ( {t}_{12 p} , {t}_{12 s} ) = ( \frac{2 {N}_{1} cos {ϕ}_{1}}{{N}_{2} cos {ϕ}_{1} + {N}_{1} cos {ϕ}_{2}} , \frac{2 {N}_{1} cos {ϕ}_{1}}{{N}_{1} cos {ϕ}_{1} + {N}_{2} cos {ϕ}_{2}} ) , & ( 5. c ) \\ ( {r}_{01 p} , {r}_{01 s} ) = ( \frac{{N}_{1} cos {ϕ}_{0} - {N}_{0} cos {ϕ}_{1}}{{N}_{1} cos {ϕ}_{0} + {N}_{0} cos {ϕ}_{1}} , \frac{{N}_{0} cos {ϕ}_{0} - {N}_{1} cos {ϕ}_{1}}{{N}_{0} cos {ϕ}_{0} + {N}_{1} cos {ϕ}_{1}} ) , & ( 5. d ) \\ ( {r}_{12 p} , {r}_{12 s} ) = ( \frac{{N}_{2} cos {ϕ}_{1} - {N}_{1} cos {ϕ}_{2}}{{N}_{2} cos {ϕ}_{1} + {N}_{1} cos {ϕ}_{2}} , \frac{{N}_{1} cos {ϕ}_{1} - {N}_{2} cos {ϕ}_{2}}{{N}_{1} cos {ϕ}_{1} + {N}_{2} cos {ϕ}_{2}} ) . & ( 5. e )\end{matrix}$$

The refractive indices of the ambient N₀, film N₁, and substrate N₂ are related to the angle of incidence in the ambient φ₀, the angle of refraction into the film φ₁, and the angle of refraction into the substrate φ₂ by the two independent equations of Snell's law;
N₀sinφ₀=N₁ sinφ₁=N₂sinφ₂. (6)

Note that, in Eq. (3), the film thickness dis isolated in the complex film-thickness exponential function X, where λ is the free-space wavelength.

The TEF of Eq. (1) is also written in the form;
τ=tan ψe^{jΔ}, (7)
where, ψ and Δ are the two ellipsometric angles. tan ψ presents the output-input relative amplitude attenuation of the p and s components, and Δ represents the corresponding relative phase shift. Accordingly, Eq. (1) and (7) are the two controlling relations of the polarization behavior of the film-substrate system.
TEF OF NON-NEGATIVE FILM-SUBSTRATE SYSTEMS

The behavior of TEF depends on the category of the film-substrate system; negative, zero, or positive. As we discussed above, the category is determined by the sign of N₁−√N₀N₂; negative for negative film-substrate system, zero for zero system, and positive for positive system. In this section, we discuss the behavior of the TEF of the two non-negative film-substrate systems, zero and positive.

Two of the basic system parameters of the film-substrate system are the film thickness d and angle of incidence φ₀. The angle of incidence is easily changed experimentally. The film thickness is a characteristic of the system under consideration that is experimentally controlled when producing the film-substrate system itself. Therefore, we start with the real φ₀-d plane. First, we move to the X-plane through a transformation, where X is the complex film-thickness exponential function given by Eq. (4). This transformation of Eq. (4) is an infinite-to-one transformation as we will show in the following subsection. Then, our second transformation is from the complex X-plane to the complex τ-plane, where τ is the complex transmission ellipsometric function TEF, given by Eq. (3). That transformation is one-to-one. Accordingly, we map any general point (φ₀, d) to the corresponding τ point, through an intermediate X point.

Zero Film-Substrate System

As mentioned before, the zero film-substrate system satisfies the condition N₁=√N₀N₂. In this section, we analyze, in detail, the performance of the TEF of this system as two successive transformations, as we just discussed above.
1. Angle Of Incidence—Film Thickness Plane (φ₀-d Plane)

The φ₀-d plane is a real plane, FIGS. 1. Equations (3) and (4) show clearly that for a constant value of the angle of incidence φ₀, and as the film thickness d is increased, starting at 0, τ repeats itself as the phase of X reaches 2π at d=D_{φ0}, where;

$${D}_{{ϕ}_{0}} = \frac{λ}{2 \sqrt{{N}_{1}^{2} - {N}_{0}^{2} {sin}^{2} {ϕ}_{0}}} . \qquad ( 8 )$$

Therefore, in FIG. 1.a, point 1 is an image of point 2. That is, the two values of τ at the two points are identical. Also, there exist an infinite number of points similar to point 2, at higher film thicknesses of multiples of D_{φ0}, where point 1 is an image to all of them. Also, point A is an image of point B. Similarly, there exist an infinite number of points similar to point B, at higher film thicknesses, where point A is an image to all of them, where;
d=dᵣ+mD_{100 0}, m=0,1,2,3, . . . , (9)
where m is the film thickness multiple; 0 is for the reduced film-thickness subdomain where,
0<dᵣ<D_{φ0}. (10)

FIG. 1.b shows the image of a constant thickness contour (φ₀-dCTC), for a specific value of the film thickness where 0<d<D_{100 0}, in the reduced film-thickness subdomain; dᵣ=d. Note that the CTC and its image coincide inside the reduced film-thickness subdomain, for that specific film thickness. FIG. 1.c shows a φ₀-dCTC of a film-substrate system where D₉₀<d<2D₀. In this case, the image is also a continuous contour. FIG. 1.d shows a φ₀-dCTC of a film-substrate system where D₀<d<D₉₀, where the image is not continuous. It is discontinued at the angle of incidence where d=D_{φ0}, where the film-substrate system acts as a bare substrate. At all higher angles of incidences, the image of the system in the reduced φ₀-d plane coincides with the φ₀-dCTC itself.

It is clear that the infinite φ₀-dplane is reduced, mathematically and behavior-wise, to the reduced portion of it, reduced film-thickness subdomain, which is a finite plane. This finite φ₀-dᵣ plane is bounded by the φ₀-axis, the D_{100 0} contour, the d-axis, and a vertical line at φ₀=90°.

A vertical line in the φ₀-d plane, at any angle of incidence, is a CAIC. It starts at point 1 and ends at point 2, as the film thickness is changed from 0 to D_{φ0}. If it continues to increase, the φ₀-dCAIC retraces itself.

For the example system we use in this communication, D₀=276.7and D₉₀=297.4, see FIGS. 1.
2. Complex Film-Thickness-Exponential Plane (X-Plane)

The first transformation in the process to obtain the ellipsometric function τ is from the φ₀-dᵣ plane to the complex film-thickness-exponential plane (X-plane). Equation (4) gives that transformation. Note that for a transparent-film system,
|X|=1, (11)
for all values of system and experimental parameters. Note that it depends on N₀ and N₁ of the system parameters, and on the two variables d and φ₀.

At d=0, and for all angles of incidence, X=±1 (point 1 in FIG. 2). Note that point 1 of FIG. 1.a corresponds to point 1 of FIG. 2. As the film thickness increases, moving vertically upward on FIG. 1.a, the corresponding image in the X-plane rotates clockwise on the unit circle. At d=D_{φ0}, the contour reaches its starting point again, X=±1, and it begins to retrace itself. That is the constant-angle-of-incidence contour in the X-plane (X CAIC). Accordingly, all X CAICs, for any angle of incidence, are the unit circle, starting and finishing at X=±71.

By direct substitution of Eq. (8) into Eq. (4);
X=e^{-j2πd/D}_{φ0} (12)
Therefore;

$$\begin{matrix}X = + 1 ∀ d = m {D}_{{ϕ}_{0}} , m = 0 , 1 , 2 , 3 , … , \\ and , & ( 13 ) \\ X = - 1 ∀ d = \frac{{D}_{{ϕ}_{0}}}{2} + m {D}_{{ϕ}_{0}} , m = 0 , 1 , 2 , 3 , … . & ( 14 )\end{matrix}$$

Therefore, the inverse image of the two points X=±1 and X=−1 of the X-plane, are the two contours D_{100 0} and D_{100 0}/2 of the φ₀-dᵣplane, respectively, see Fig. (3). Those four elements, the two points and the corresponding two conOturs, of the two corresponding planes are of special importance.

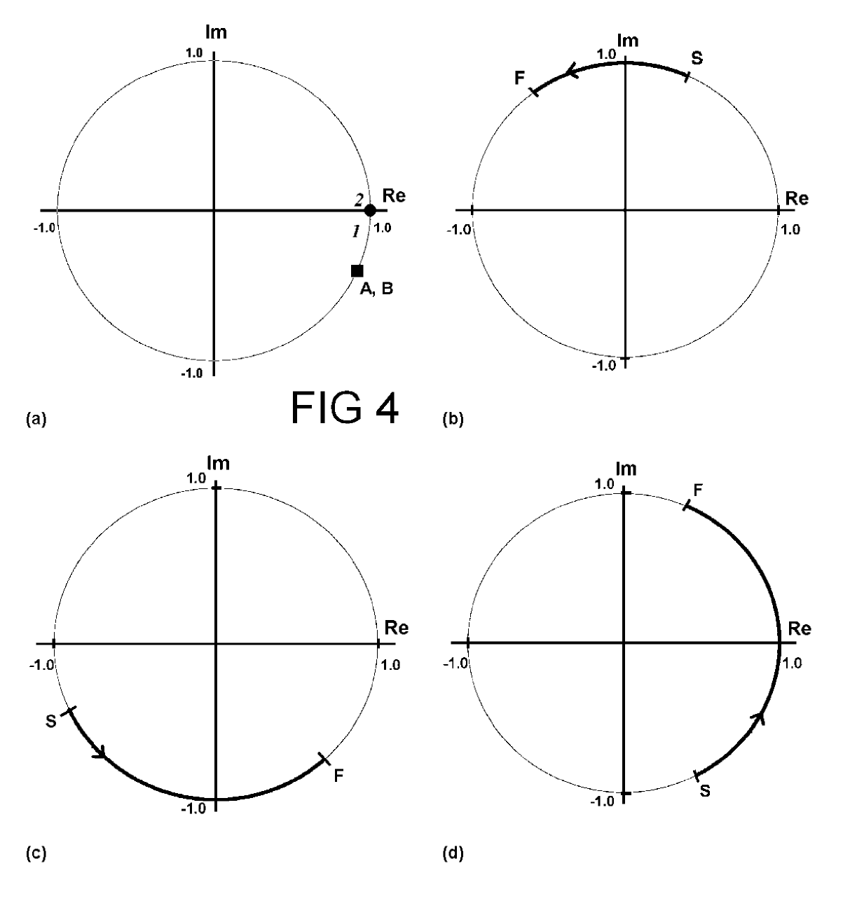

FIGS. 4 show the constant-thickness contours in the X-plane (XCTCs). The XCTC is an arc of the unit circle of a different length for a different film thickness, with points moving counter-clockwise as the angle of incidence is increased. For a larger film thickness, the starting point moves clockwise, with the direction of increase of the arc still being counter-clockwise.

The points X=±1 and X=−1, divide the family of XCTC's into four subfamilies (SFs), FIG. 5. The first subfamily (SF1) has all of its XCTC's starting and finishing in the lower half of the unit circle, i.e. all the contours do not cross neither of the two points X=±1 nor X=−1. The second subfamily (SF2) has all of its contours crossing the point of X=−1. The third subfamily (SF3) has all of its contours starting and finishing in the upper half of the unit circle. None of the contours of this subfamily crosses neither of the two points X=−1 nor X=±1. The fourth subfamily (SF4) has all of its contours crossing the point X=±1.

With reference to FIG. 3 of the φ₀-dplane, the inverse images of the points X=−1 and X=±1 are the D_{100 o}/2and D_{100 0} contours, respectively. Accordingly, SF1 is where 0 <d<D_{100 0}/2, SF2 is where d=D_{100 0}/2, SF3 is where D_{φ0}/2<d<D_{100 0}, and SF4 is where d=D_{100 0}. The importance of the four SFs is discussed in the following subsection.

3. Complex TEF Plane (τ-Plane)

In this subsection, we study the CAICs and CTCs in the complex TEF plane.

A. CAICs

The second transformation to obtain the transmission ellipsometric function τ is from the X-plane to the τ-plane and is given by Eq. (3). This transformation is a bilinear transformation, with the condition;
B·C, (15)
which is satisfied for the transparent film-substrate system under consideration. The bilinear transformation maps a circle onto a circle. Therefore, Eq. (3) maps the unit circle, which is the X CAIC for any angle of incidence, to a circle in the τ-plane. FIG. 6 shows the contours for the zero film-substrate system. The τ CAIC for perpendicular incidence, φ₀ =0, is the point τ=+1. It is the counter-clockwise class of the τ CAICs. For any angle of incidence φ₀>0, the τ CAIC is a circle, starting at point 1 and rotating clockwise as the film thickness is increased, constituting the clockwise class. As the angle of incidence is increased, the diameter of the circle is increased, and the center of the circle moves to the right on the real axis, FIG. 6. All τ CAIC's are enclosed within the τCAIC(90).
B. CTCs

The τCTCs all start at T=+1, where φ₀=0, and end on a corresponding point on τCAIC(90); a point on that circle. Each τCTC ends at a different point on τCAIC(90) corresponding to its value, see FIGS. 1, 2, and 6. Here, we also have four SFs, according to the value of the film thickness d. SF1 starts with the bare substrate at d=0, where it coincides with the real axis starting at τ=+1 and finishes on τCAIC(90) at τ=N₂/N₀. As d increases, members of SF1 continue to be generated, all starting at τ=+1 and ending on τ CAIC(90), each becoming steeper and all moving downward in the lower half of the complex τ-plane until well past the bottom point of the finishing contour. As the film thickness increases, the contours get farther and farther from the real axis, FIG. 7.a.

SF2 starts with τCTC(108.4), which also starts at τ=+1 and loops upwards in a counter-clockwise direction and goes back through τ=+1 at φ₀·0, then continues downward to end on τCAIC(90), FIG. 7.b. As the film thickness increases, the upper half loop enlarges and the lower half part shortens and approaches τCAIC(90) faster at a higher point closer to τ=+1. The point of τ=+1 is, therefore, a point of infinite multiplicity of the ellipsometric function τ. For SF2 at τ=+1, the transformation of Eq. (3) is a one-to-one transformation. Note that the corresponding transformation of Eq. (4) is an infinite-to-one transformation. Accordingly, the combined transformation of the two is an infinite-to-one transformation. That is, the infinite points of the D_{φ0}/2 all map onto the single point X=−1, then it maps onto the single point τ=+1.

SF3 starts with τCTC(216.7⁺). The contour starts at τ=+1, as always, where φ₀=0. As the angle of incidence increases, the contour loops counter-clockwise upwards, in the upper half of the complex plane to terminate on the τCAIC(90), FIG. 7.c. Note that it encloses the loops of SF2, but terminates on the τCAIC(90) instead of the point τ=+1. The contour of a higher film thickness has a higher termination point, and the contours fan out. All the contours are in the upper half of the complex plane and do not cross the real axis.

It is important to realize the fact that none of τCAICs of SF1, SF2, and SF3 intersects with other contours of the same SF or of another. Starting with SF4, one has to be careful, and recognize the fact that the upper boundary of the reduced thickness domain on the φ₀-dplane, the φ₀-dᵣplane, is a curve and not a horizontal straight line; D_{φ0}. Therefore, the first part of the contour is not in the reduced thickness plane, dashed portion of the CTCs of FIG. 7.d.

SF4 starts with τCTC(216.7), of D₀. As all CTCs, it starts at τ=+1. As the angle of incidence increases, the contour moves downward into the lower half of the complex plane and then curves upward to cross the real axis and terminates on the τCAIC(90). As the film thickness increases, the contours fan out with the real-axis crossing-point moving to the right.

Increasing the film thickness to D₉₀₊(=297.4⁺) leads to a film thickness that is completely outside of the reduced thickness plane. No part of that CTC coincides with its image in the φ₀-dᵣplane, and all of its τCTC is imaged with other τCTCS, i.e. it intersects with other contours of other SFs at each and every point.

FIG. 8 gives a collective account of the CAICs and CTCs of the zero film-substrate system.

POSITIVE FILM-SUBSTRATE SYSTEM

The positive film-substrate system is where N₁>√N₀N₂. As we discussed in the previous subsections, the relative values of the refractive indices of the ambient N₀, the film N₁, and the substrate N2control the behavior of the transmission ellipsometric function τ. Only N₀ and N₁ control the behavior in the φ₀-dᵣplane, and accordingly in the extended φ₀-dplane. Also, only N₀ and N₁ control the behavior in the X-plane. N₀, N₁, and N2control it in the complex Tplane. In the following subsections, we examine the behavior of TEF in the three domains of interest.

1. φ₀-dᵣ Plane

As the φ₀-dᵣplane is governed only by the values of the refractive indices of the ambient N₀ and of the film N₁, therefore all the discussions of Sec. 3.A.1 hold for the positive film-substrate system. ²¹ The only changes are in the actual values of D₀/2, D₉₀/2, D₀, and D₉₀, if either N₀ or N₁ is changed. For the example positive system we use in this communication, D₀=229.3 and D₉₀=332.7, see FIGS. 1.

2. Complex X-Plane

As the complex X-plane is also only controlled by N₀ and N₁, and by the transformation of Eq. (4), the discussions of Sec. 3.A.2 hold for the case of a positive film-substrate system. ²² The only changes, if N₀ and N₁ change, are in the actual values of d=D₀ corresponding to the point X=+1, and of d=D₀/2 corresponding to the point X=−1, see FIGS. 2 and 3. Also, the start and finish points of FIG. 4 will correspond to N₀ and N₁ of the system.

3. Complex τ-Plane

In this section, we study the behavior of the TEF in the complex τ-plane keeping one of the two parameters of the film thickness dand angle of incidence φ₀constant, and changing the other, as we did in Sec. 3.A.3.

A. CAICs

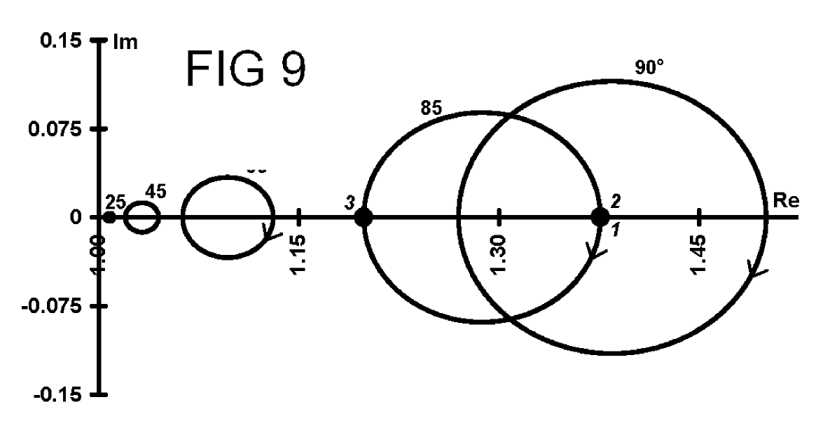

The CAICs of the positive system are shown in FIG. 9. They are all circles with their centers on the real axis. At φ₀=0, the contour collapses to the point τ=+1, which is the counter-clockwise class of the CAICs. As the angle of incidence increases, the center of the contour moves to the right on the real axis, and its diameter increases. Each contour starts at its respective point 1 on the real axis where d=0, and rotates clockwise into the lower half of the complex plane; clockwise class. Each then intersects the real axis again at its respective point 3 where d=D_{φ0}/2, and rotates into the upper half plane back to the starting point where d=D_{φ0}, which is equivalent to the bare substrate, see FIGS. 1, 2, and 3.

Point 1, as the starting point at zero film thickness, relates the three contours of FIGS. 3, 2, and 9, as the outcome of two successive transformations, of Eqs. (4) and (3), relating the three planes; φ₀-dᵣ plane, X-plane, and τ plane. Point 3, as the intermediate point at d=D_{φ0}/2, and point 2 as the finishing point at d=D_{φ0} which coincides with point 1, do the same. Those three points are actually two pivots for each contour. All are on the real axis.

Each two of the CAICs intersect at two angles of incidence, each at a different film thickness; a different pair of (d, φ₀). This means that the correspondence between the φ₀-dᵣ plane and the τ-plane is a two-to-one and not a one-to-one as in the zero system. Accordingly, each point in the τ domain corresponds to two points in the φ₀-dᵣdomain. That is true except inside the CAIC(90) and on part of its circumference. No CAICs intersect inside the CAIC(90) and on the right half of it, starting and ending slightly to the left of the upper- and lower-most points.

B. CTCs

As in the case of zero film-substrate system, the CTCs are divided into four SFs. Those subfamilies are determined by N₀ and N₁, first in the φ₀-dᵣ plane as we discussed before. All the CTCs start at the point τ=+1, where the angle of incidence is zero, and ends at the corresponding point on the τ CAIC(90).

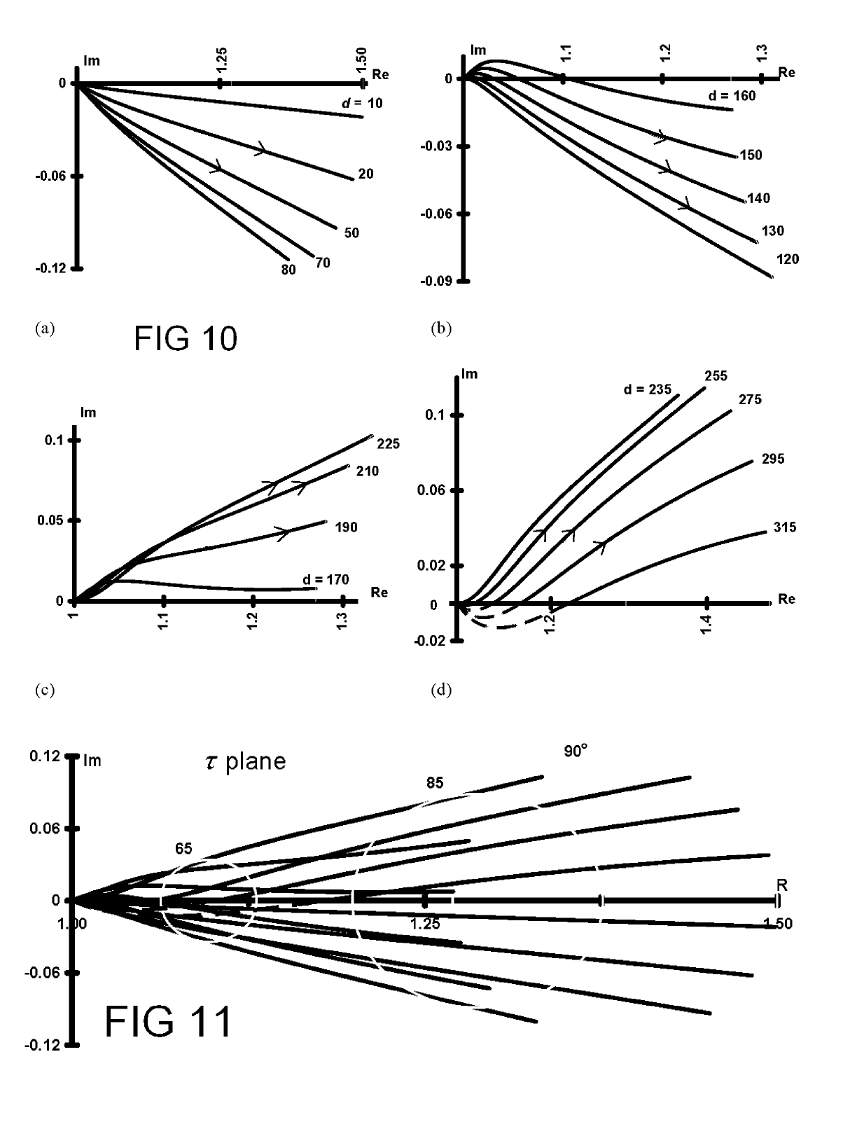

The first contour of SF1 is that for the bare substrate where d=0. It coincides with the real axis starting at point τ=+1 and ends at point 1 of the τ CAIC(90) where τ=N₂/N₀, FIG. 10.a. As the film thickness is increased, the corresponding contour fans out downward spanning a trajectory in the lower half plane. Some of the contours with largest film thicknesses of SF1 intersect each other; two-to-one correspondence discussed above. As the film thickness is increased, its CTC ends on a lower point of the τCAIC(90) until the lowest point is passed. The highest film thickness of SF1 ends at a point higher than the lowest one. This indicates that the CTCs intersection starts past the lowest point.

The first contour of SF2, FIG. 10.b, of lowest thickness in this subfamily, of d=D₀/2 (=114.6) starts at the point τ=1, as all others, moves upward to the right in the upper half plane, then curves down to intersect the real axis closest to τ=+1, and ends at a slightly higher point on the τ CAIC(90). The CTC of each successively larger film thickness intersects the real axis at a point farther to the right and ends at a higher point on the τCAIC(90). The largest CTC ends on the left-most point of τCAIC(90) where τ=N₁²/N₀ N₂. Note that the CTCs of SF2 do not intersect each other, but they intersect with those of SF1. There only exist an intersection of two CTCs, not more, at each point to the left of the τCAIC(90) and on its lower-left quarter, and not inside.

The first contour of SF3, FIG. 10.c, of the lowest thickness in this subfamily, of d=D₉₀+/2(=166.3⁺) starts at the common point of τ=1, and moves upward to the right in the upper half plane, then curves down to end on the τCAIC(90) slightly above the real axis. All other successive members of the subfamily end at a successively higher point of that circle. Note that the contours intersect each other; two-to-one mapping. The largest film thickness contour ends at a lower than the top point of the τCAIC(90). The CTCs all end on the upper-left quarter of the τCAIC(90), and no intersection of the CTCs exists inside it, only on that part of the circumference.

The first contour of SF4, FIG. 10.d, of the lowest thickness in the subfamily, of d=D₀(=229.3) starts at τ=+1. It moves down into the lower complex half plane, and then curves upward to cross the real axis closest to τ=+1, ending high on the finishing CAIC. As the film thickness increases successively, the contours curve down deeper to cross the real axis at successively father points from τ=+1. Here, also, note that the dotted part of the curve is actually the image of the contour, see FIG. 1. In this SF, the contours do not intersect each other, but intersect those of SF3. Therefore, no intersection of the CTCs exists inside the τCAIC(90), or on its corresponding part of its circumference.

FIG. 11 gives a complete account of the CAICs and CTCs of the positive system, note the two-to-one mapping.

Transmission Devices

The above comprehensive analysis explains clearly the polarization behavior of the film-substrate system through the use of TEF. In this section, we discuss the behavior of the film-substrate system as a transmission polarization-device. We also discuss which devices exist.

The polarization device is defined as a film-substrate system required to affect the incident wave and introduce a prescribed polarization-change given by;
τ=tan ψe^{jΔ}, (7)
where, tanψ is the relative amplitude-attenuation and Δ is the relative phase-change introduced by the device.

It is clear that the case of an unsupported film is a special case of the film-substrate system with N₂=N₀. This case is discussed in a separate publication.

Zero Film-Substrate System

FIG. 8 shows the behavior of TEF of the zero film-substrate system. The domain of the function is on and inside the τCAIC(90). At any point within that domain, the film-substrate system behaves as a polarization device. A polarization device, therefore, exists at any of those points. The existing relative phase-retardation A at any angle of incidence φ₀is bounded by;
− [symbol] Δ≦Δ≦ [symbol] Δ, (16.a)

$$Δ • = {sin}^{- 1} \frac{( {N}_{2} - {N}_{0} ) ( cos {ϕ}_{2} - cos {ϕ}_{0} ) }{( {N}_{2} + {N}_{0} ) ( cos {ϕ}_{2} + cos {ϕ}_{0} )} . \qquad ( 16 . b )$$

The existing relative amplitude-attenuations at the same angle of incidence are bounded by;

$$1 \leq tan ψ \leq \frac{{N}_{0} cos {ϕ}_{0} + {N}_{2} cos {ϕ}_{2}}{{N}_{2} cos {ϕ}_{0} + {N}_{0} cos {ϕ}_{2}} , \qquad ( 17 )$$

FIG. 12.a shows the change of the boundary value of the relative phase-shift Δ\hat{0} with the angle of incidence for different film-substrate systems, maintaining the zero system. It shows that the boundary increases exponentially with the angle of incidence. To obtain larger relative phase shifts, one should use larger index materials at larger angles of incidence.

FIG. 12.b shows its change with the system (system's substrate refractive index N₂) at constant angles of incidence. As it is clear from the figure, the maximum phase retardation increases with the system's N2for the same angle of incidence, reaching about fifty degrees for N₂=6. Also, it is clear that the maximum phase retardation increases as the angle of incidence increases, for the same system.

The change of the upper-boundary value of the relative amplitude attenuation with the angle of incidence for the same system is shown in FIG. 13.a for different systems. As the figure shows, the upper-boundary value increases exponentially with the angle of incidence for the same system. It also increases, for the same angle of incidence, as the system's N2increases. The lower-boundary is the horizontal line at tan ψ=1. It shows that the range of existing relative amplitude attenuation increases exponentially with the angle of incidence. Therefore, use of a larger index system at higher angles of incidence provides a larger value of relative amplitude attenuation.

In FIG. 13.b, the change of the relative amplitude attenuation upper-boundary with the system, for different angles of incidence, is shown. The largest absolute value of TEF is obtained at grazing incidence, and is equal to N₂/N₀; the 45° straight line. As the system changes, with N2increasing, the upper-bound obviously increases, for the same angle of incidence.

Note that the lower-boundary valuefor the relative amplitude attenuation is unity at all angles of incidence and for all film-substrate systems.

For a given zero film-substrate system, the physically existing Δ and tan ψ pare bounded by the τCAIC(90), where;

$$\begin{matrix}Δ • = {sin}^{- 1} ( \frac{{N}_{2} - 1}{{N}_{2} + 1} ) , & ( 18 ) \\ 1 \leq \begin{matrix}• \\ tan \\ \end{matrix} ψ \leq \frac{{N}_{2}}{{N}_{0}} . & ( 19 )\end{matrix}$$

General-Device Design

For any device values of Δ and tan ψ, we have the following design equations to determine the design parameters d and φ₀;

$$\begin{matrix}( {ϕ}_{0} , k ) = ( {sin}^{- 1} ( \frac{\sqrt{1 - {( \frac{1}{k} )}^{2}}}{1 - \frac{{N}_{0}}{{N}_{2}}} ) , \frac{cos Δ - tan ψ}{cot ψ - cos Δ} ) , & ( 20 ) \\ {d}_{r} = \frac{- λ}{4 π \sqrt{{N}_{1}^{2} - {N}_{0}^{2} {sin}^{2} {ϕ}_{0}}} arg ( X ) , & ( 21 ) \\ X = \frac{u τ - 1}{v - uw τ} , & ( 22 )\end{matrix}$$

and, τ is the required device characteristic given by Eq. (7), and;

$$( u , v , w ) = ( \frac{{t}_{01 s} {t}_{12 s}}{{t}_{01 p} {t}_{12 p}} , {r}_{01 s} {r}_{12 s} , {r}_{01 p} {r}_{12 p} ) . \qquad ( 23 )$$

t₀₁ₚ, t₀₁ₛ, t₁₂ₚ, t₁₂ₛ, r₀₁ₚ, r₀₁ₛ, r₁₂ₚ, r₁₂ₛ are given by Eqs. (5.b)-(5.e). dᵣ is the smallest (reduced) film thickness where the film-substrate system acts as a required. For higher film thicknesses, we add multiples of the film-thickness periods;

$$d = \frac{- λ}{4 π \sqrt{ {N}_{1}^{2} - {N}_{0}^{2} {sin}^{2} {ϕ}_{0}}} [ arg ( X ) - 2 π m ] , m = 1 , 2 , 3 , … . \qquad ( 24 )$$

A simple design algorithm is evident;

(1) 1. Determine the required device performance-parameters (tan ψ, Δ).

(2) 2. Choose the design-system's optical constants (N₀, N₂), where N₁=√N₀ N₂.

(3) 3. Calculate the design angle of incidence φ₀using Eq. (20).

(4) 4. Calculate the design film thickness dusing Eq. (24), with the proper choice of m.

The choice of m helps with obtaining a film thickness of choice, from the infinite values available. For example, this choice might be due to manufacturing constraints or preferences.

Retarder Design

The retarder is a special case of polarization devices where tan ψ=1. ¹¹ The retardation (rotation) angle can assume any design value. From FIGS. 6 and 8, we recognize the fact that the only retarder device that could be realized using zero film-substrate systems is a retarder with zero retardation angle Δ=0, point τ=+1. Since this retarder is of a retardation angle of zero and it occupies the point of +1 in the complex τ-plane, the idea of investigating the possibility of its existence is appealing. ²³

From FIG. 2, we recognize the fact that the inverse image of τ=+1 in the X-plane is point 3 where X=−1. We also recognize from FIG. 3 that the inverse image of X =−1 in the φ₀−dᵣ plane is point 3, where d=Dφ₀/2. Therefore, there exist an infinite number of design pairs of (φ₀, dᵣ)where the zero system behaves as a retarder. Therefore, the design equations for the retarder are;

$${d}_{r} = \frac{λ}{4 \sqrt{{N}_{1}^{2} - {N}_{0}^{2} {sin}^{2} {ϕ}_{0}}} . \qquad ( 25 )$$

That is the smallest (reduced) film thickness where the film-substrate system performs as a retarder at the chosen angle of incidence φ₀. For higher film thicknesses, we add multiples of the film-thickness periods. Therefore;
d=dᵣ+mD_{φ0}, m=1,2,3, . . . , (26)

$$d = \frac{( 1 + 2 m ) λ}{4 \sqrt{{N}_{1}^{2} - {N}_{0}^{2} {sin}^{2} {ϕ}_{0}}} , m = 0 , 1 , 2 , 3 , … \qquad ( 27 )$$

If we start with selecting the film thickness dfirst, the angle of incidence is then given by;

$${ϕ}_{0} = {sin}^{- 1} ( \sqrt{{( \frac{{N}_{1}}{{N}_{0}} )}^{2} - {( \frac{1 + 2 m}{4 {N}_{0} d} λ )}^{2}} ) , m = 0 , 1 , 2 , 3 … \qquad ( 28 )$$

It is also possible to use the design equations for the general case with the proper choice of tanψ=1. The only retarder design achievable with the zero system is that with Δ=0°, as we mentioned above. Therefore, the device design is obtained by substituting τ=1 into the general design equations, Eqs. (20) and (24). If there is no operating angle of incidence or film thickness preference to start with, the design of a larger transmittance is then the one to use; designs at lower angles of incidence.

Linear Partial Polarizer Design

A linear partial polarizer (LPP) is a device that introduces a relative amplitude-attenuation, but not a phase-retardation. From FIG. 8, we recognize the intersection points with the real axis as LPP's. Considering FIGS. 2, 3, and 6 it is obvious that the film-substrate system functions as an LPP at points 1 and 2, where the system is, or is equivalent to, a bare substrate; dᵣ=0 and dᵣ=D_{φ0}, respectively. Therefore, at higher film thicknesses;

$$\begin{matrix}d = \frac{m λ}{2 \sqrt{{N}_{1}^{2} - {N}_{0}^{2} {sin}^{2} {ϕ}_{0}}} , m = 0 , 1 , 2 , 3 , … , \\ & ( 29 ) \\ tan ψ = \frac{{N}_{0} cos {ϕ}_{0} + {N}_{2} cos {ϕ}_{2}}{{N}_{2} cos {ϕ}_{0} + {N}_{0} cos {ϕ}_{2}} . \\ & ( 30 ) \\ {ϕ}_{0} = {sin}^{- 1} \sqrt{\frac{{N}_{2}^{2} ( {tan}^{2} ψ - 1 ) ( {N}_{2}^{2} - {N}_{0}^{2} )}{{{N}_{2}^{2} ( tan ψ {N}_{2} + {N}_{0} )}^{2} - {{N}_{0}^{2} ( {N}_{2} - tan ψ {N}_{0} )}^{2}}} . & ( 31 )\end{matrix}$$

The design procedure of an LPP is summarized in the following algorithm;

1. Select the relative amplitude attenuation of the LPP; value of tan ψ.

2. Select the materials for the film-substrate system; value of N₂.

3. Calculate the design angle of incidence sousing Eq. (31).

4. Calculate the design film-thickness dusing Eq. (29).

5. Choose m for manufacturing purposes, or otherwise.

It is also possible to use the design equations for the general case with the proper choice of Δ=0° and the required value of tan ψ, where

$$1 \leq tan ψ < \frac{{N}_{2}}{{N}_{0}} ,$$

as limited by Eq. (19). There are an infinite number of LPP designs achievable with the zero system within that limit. Therefore, the LPP design is obtained by substituting the values of choice into the general design equations, Eqs. (31 ) and (29). If there is no preferred operating angle of incidence or film thickness preference, then the design of a larger transmittance is the one to use; designs at lower angles of incidence.
Positive Film-Substrate System

The TEF of the positive film-substrate system has a distinctively different behavior from that of the zero system, as discussed above. FIG. 11 shows the behavior of TEF for the positive system. The domain of the function is inside an equilateral triangle with its apex at the origin and its base is a vertical line at the point (N₂/N₀, 0)with a base-length of

$$\frac{{N}_{2}^{2} - {N}_{1}^{2}}{{N}_{0} {N}_{1}} .$$

Note that the domain does not completely fill that triangle. At any point within that domain, the film-substrate system behaves as a polarization device. A polarization device, therefore, exists at any of those points. The retardation angles that exist at any angle of incidence Φ₀ are bounded by;

$$\begin{matrix}- {Δ}^{•} \leq Δ \leq {Δ}^{•} , \\ & ( \text{32.a} ) \\ {Δ}^{•} = {sin}^{- 1} \frac{\begin{matrix}{N}_{0} cos {ϕ}_{2} ( {N}_{2}^{2} - {N}_{1}^{2} ) ( {cos}^{2} {ϕ}_{0} - {cos}^{2} {ϕ}_{1} ) + \\ {N}_{2} cos {ϕ}_{0} ( {N}_{1}^{2} - {N}_{0}^{2} ) ( {cos}^{2} {ϕ}_{2} - {cos}^{2} {ϕ}_{1} )\end{matrix}}{\begin{matrix}{N}_{0} cos {ϕ}_{2} ( {N}_{2}^{2} + {N}_{1}^{2} ) ( {cos}^{2} {ϕ}_{0} + {cos}^{2} {ϕ}_{1} ) + \\ {N}_{2} cos {ϕ}_{0} ( {N}_{1}^{2} + {N}_{0}^{2} ) ( {cos}^{2} {ϕ}_{2} + {cos}^{2} {ϕ}_{1} )\end{matrix}} & ( \text{32.b} )\end{matrix}$$

The relative amplitude-attenuations that exist at the same angle of incidence are bounded by;

$$\frac{{N}_{0} {N}_{2} cos {ϕ}_{0} cos {ϕ}_{2} + {N}_{1}^{2} {cos}^{2} {ϕ}_{1}}{{N}_{0} {N}_{2} {cos}^{2} {ϕ}_{1} + {N}_{1}^{2} cos {ϕ}_{0} cos {ϕ}_{2}} \leq tan ψ \leq \frac{{N}_{0} cos {ϕ}_{0} + {N}_{2} cos {ϕ}_{2}}{{N}_{2} cos {ϕ}_{0} + {N}_{0} cos {ϕ}_{2}} , \qquad ( 33 )$$

Note that in this case, the two boundaries of the retardation angle and the lower boundary of the relative amplitude-attenuation depend on the three refractive indices of the system, ambient N₀, film N₁, and substrate N₂. Also note that the upper boundary of the relative amplitude-attenuation still depends only on the refractive indices of the ambient and substrate, and not on that of the film. For this system, both boundaries for the relative amplitude-attenuation change with the angle of incidence, in contrast to the case of the zero system where the lower boundary is identically unity for all angles of incidence. For the positive system, that boundary is only unity for perpendicular incidence.

FIG. 14.a shows the change of the boundary value of the relative phase-shift with the angle of incidence for different film-substrate systems, maintaining the positive system. It shows that the boundary changes exponentially with the angle of incidence.

FIG. 14.b shows its change with the system (system's substrate refractive index N₂) at constant angles of incidence. As it is clear from the figure, the maximum phase retardation increases with the system's N2for the same angle of incidence, reaching about eighteen degrees for N₂=6. Also, it is clear that the maximum phase retardation increases as the angle of incidence increases, for the same system.

To obtain larger relative phase shifts, one should to use larger index materials at larger angles of incidence.

The change of the upper- and lower-boundary values of the relative amplitude-attenuation with the angle of incidence for different system is shown in FIG. 15.a for different values of the system's N₂. As the figure shows, the two boundary values increase exponentially with the angle of incidence for the same system. It also increases, for the same angle of incidence, as the system's N2increases. For the positive system, the lower-boundary is not the horizontal line at tan ψ=1. It is clear that the range of existing relative amplitude attenuation increases exponentially with the angle of incidence.

In FIG. 15.b, the change of the relative amplitude-attenuation upper- and lower-boundaries with the system, for different angles of incidence, is shown. The largest absolute value of TEF is obtained at grazing incidence, and is equal to N₂/N₀; the 45° straight line. As the system changes, with N2increasing, the upper-bound obviously increases, for the same angle of incidence.

Note that the lower-boundary value for the relative amplitude attenuation is decreasing as the angles of incidence increase, and for all systems. The available margin of tan ψ increases greatly with the angle of incidence, from zero at the bare substrate to a relatively large value at the zero system.

For a given positive film-substrate system, the existing Δ and tan ψ are bounded by that of the τCAIC(90), where;

$$\begin{matrix}{Δ}^{•} = {sin}^{- 1} ( \frac{{N}_{2}^{2} - {N}_{1}^{2}}{{N}_{2}^{2} + {N}_{1}^{2}} ) , & ( 34 ) \\ 1 < {tan}^{•} ψ \leq \frac{{N}_{2}}{{N}_{0}} . \\ {Δ}^{•} = 4 \text{.} 77 and 1 < tan ψ \leq 1 \text{.} 5 . & ( 35 )\end{matrix}$$

Both are attained at grazing incidence. Note that the larger the film-substrate index contrast (N₂−N₁), the larger Δ\hat{0} is, and the larger N₂the larger tan ψ.

General-Device Design

For any required device performance-parameters of Δand tan ψ, the following design equations are used to determine the design parameter φ₀ for the positive system;

$$\begin{matrix}( {ϕ}_{01} , {ϕ}_{02} , {ϕ}_{03} ) = ( {sin}^{- 1} \sqrt{{N}_{14} - \frac{{N}_{11}}{3 {N}_{14}} - \frac{{D}_{13}}{3}} , {sin}^{- 1} \sqrt{{N}_{15} - \frac{{N}_{11}}{3 {N}_{15}} - \frac{{D}_{13}}{3}} , {sin}^{- 1} \sqrt{{N}_{16} - \frac{{N}_{11}}{3 {N}_{16}} - \frac{{D}_{13}}{3}} ) , & ( 36 ) \\ ( {N}_{11} , {N}_{12} , {N}_{13} ) = ( {D}_{14} - \frac{{D}_{13}^{2}}{3} , - {D}_{15} - \frac{{D}_{13} {D}_{14}}{3} + \frac{2 {D}_{13}^{3}}{27} , - \frac{{N}_{12}}{2} + \sqrt{\frac{{N}_{12}^{2}}{4} + \frac{{N}_{11}^{3}}{27}} ) , & ( 37 ) \\ ( {N}_{14} , {N}_{15} , {N}_{16} ) = ( \sqrt[3]{{N}_{13}} , {ⅇ}^{j \frac{π}{1 \text{.} 5}} {N}_{14} , {ⅇ}^{j \frac{π}{1 \text{.} 5}} {N}_{15} ) , & ( \text{38.a} ) \\ ( {D}_{12} , {D}_{13} , {D}_{14} , {D}_{15} ) = ( ( {D}_{6}^{2} - {D}_{8}^{2} ) {N}_{2}^{2} , \frac{{D}_{10}}{{D}_{9}} , \frac{{D}_{11}}{{D}_{9}} , - \frac{{D}_{12}}{{D}_{9}} ) , & ( \text{38.b} ) \\ {D}_{11} = ( {D}_{8}^{2} + 2 {D}_{7} {D}_{8} - 2 {D}_{5} {D}_{6} ) {N}_{2}^{2} - {D}_{6}^{2} {N}_{0}^{2} , & ( \text{38.c} ) \\ ( {D}_{9} , {D}_{10} ) = ( {D}_{7}^{2} {N}_{2}^{2} - {D}_{5}^{2} {N}_{0}^{2} , ( {D}_{5}^{2} - {D}_{7}^{2} - 2 {D}_{5} {D}_{8} ) {N}_{2}^{2} + 2 {D}_{5} {D}_{6} {N}_{0}^{2} ) , & ( \text{38.d} ) \\ ( {D}_{7} , {D}_{8} ) = ( ( {D}_{1} {N}_{2}^{2} + {D}_{4} {N}_{1}^{2} ) {N}_{0}^{2} , ( {D}_{1} + {D}_{4} ) {N}_{1}^{2} {N}_{2}^{2} ) , & ( \text{38.e} ) \\ ( {D}_{5} , {D}_{6} ) = ( ( {D}_{3} {N}_{0}^{2} + {N}_{2} {N}_{1}^{2} ) {N}_{2}^{2} , ( {D}_{2} + {D}_{3} ) {N}_{1}^{2} {N}_{2}^{2} ) , & ( \text{38.f} ) \\ ( {D}_{3 ,} {D}_{4} ) = ( tan ψ ( tan ψ {N}_{7} {N}_{8} - cos Δ ( 1 + {N}_{7} {N}_{8} ) ) + {N}_{8} , tan ψ ( tan ψ - cos Δ ( {N}_{7} + {N}_{8} ) ) + {N}_{7} {N}_{8} ) , & ( \text{38.g)} \\ ( {D}_{1} , {D}_{2} ) = ( tan ψ ( tan ψ {N}_{7} - cos Δ ( {N}_{7} + {N}_{8} ) ) + 1 , tan ψ ( tan ψ {N}_{8} - cos Δ ( 1 + {N}_{7} {N}_{8} ) ) + {N}_{7 } ) , & ( 38. h ) \\ ( {N}_{7} , {N}_{8} ) = ( \frac{{N}_{0} {N}_{2}}{{N}_{1}^{2}} , \frac{{N}_{2}}{{N}_{0}} ) . & ( \text{38.i} )\end{matrix}$$

Equations (36) give three values for the angle of incidence at which the device provides the required relative amplitude-attenuation and relative phase-shift. The three angles of incidence are all mathematically correct. Complex angles of incidence are to be rejected at this stage, and only real angles of incidence, which are also physically correct, are accepted. Note that for the positive film-substrate system, two sets of solutions (ψ₀, d₁)and (φ₀₂, d2)exist, see Sec. 3. B.

The next step is to obtain the design film thickness. Equations (22)-(24) are valid and are to be used.

As an example, if a device performance of a relative amplitude-attenuation of 1.1806and relative phase-shift of 1.2338° is required; Eqs. (36) are used and give the three angles of incidence of 90.0-j55.1745which is rejected, 82.9891° which is accepted, and 72.0° which is also accepted. Now, Eqs. (22)-(24) are used to give the reduced film thicknesses of 182.05 and 287.92 nm, respectively. Therefore, the two positive film-substrate systems each of N₁=1.38 and N₂=1.5, in air, and of (82.9891°, 182.05 nm) and (72°, 287.92 nm) both provide the required relative amplitude-attenuation and phase-shift. From Eq. (24) we can find an infinite number of systems, by changing the film thickness, which provides the same device performance.

As discussed in Sec. 3.B.3.A, the two-t0-one correspondence of TEF exists outside the CAIC(90) and on the left half of it, slightly to the left. Accordingly, two device-designs exist for each required performance in that domain, and only one exists inside. Any point on the CAIC(90) satisfies the equation;

$$Δ = {cos}^{- 1} \frac{{N}^{2} ( {N}_{0}^{2} {tan}^{2} ψ + {N}_{1}^{2} )}{{N}_{0} tan ψ ( {N}_{1}^{2} + {N}_{2}^{2} )} , \qquad ( 39 )$$

and the boundary conditions for the one-to-two correspondence not to exist are;

$$\begin{matrix}tan ψ > \frac{1}{\sqrt{2}} \sqrt{{( \frac{{N}^{2}}{{N}_{0}} )}^{2} + {( \frac{{N}_{1}^{2}}{{N}_{0} {N}_{2}} )}^{2}} , & ( 40 ) \\ - {Δ}_{B} < Δ < {Δ}_{B} , & ( 41 ) \\ {Δ}_{B} = {tan}^{- 1} \frac{{N}_{2}^{2} - {N}_{1}^{2}}{{N}_{2}^{2} + {N}_{1}^{2}} . & ( 42 )\end{matrix}$$

Retarder Design

As we discussed before, the retarder is a special case of polarization devices where tan ψ=1. In general, the retardation angle can assume any design value. From FIG. 9, we recognize the fact that no retarder device can be obtained using positive film-substrate systems; no CAIC intersects the unit circle except at the point τ=+1 at perpendicular incidence where light is transmitted through the film-substrate system unaffected with a transmittance value of unity.

Linear Partial Polarizer Design

Also, as we discussed before, a linear partial polarizer (LPP) is a device that introduces a relative amplitude-attenuation, but not a relative phase-retardation. Again, from FIGS. 9 and 11, we recognize the intersection points with the real axis as LPP's. Considering FIGS. 1, 2, and 3, it is obvious that the film-substrate system functions as an LPP at points 1 and 2, where the system is, or is equivalent to, a bare substrate; dᵣ=0 and dᵣ=D_{φ0}, respectively, and at point 3 where dᵣ=D_{φ0}/2. Therefore, at higher film thicknesses, and for points 1 and 2;

$$\begin{matrix}d = \frac{m λ}{2 \sqrt{{N}_{1}^{2} - {N}_{0}^{2} {sin}^{2} {ϕ}_{0}}} , m = 0 , 1 , 2 , 3 , … , & ( 43 ) \\ tan ψ = \frac{{N}_{0} cos {ϕ}_{0} + {N}_{2} cos {ϕ}_{2}}{{N}_{2} cos {ϕ}_{0} + {N}_{0} cos {ϕ}_{2}} , & ( 44 ) \\ {ϕ}_{0} = {sin}^{- 1} \sqrt{\frac{{N}_{2}^{2} ( {tan}^{2} ψ - 1 ) ( {N}_{2}^{2} - {N}_{0}^{2} )}{{{N}_{2}^{2} ( tan ψ {N}_{2} + {N}_{0} )}^{2} - {{N}_{0}^{2} ( {N}_{2} - tan ψ {N}_{0} )}^{2}} .} & ( 45 )\end{matrix}$$

And, the algorithm of Sec. 4.A.3 applies. Note that for a given film-substrate system

$$tan {ψ}_{1 , 2} \leq \frac{{N}_{2}}{{N}_{0}} ,$$

depending on the angle of incidence. At grazing incidence,

$$tan {ψ}_{1 , 2} = \frac{{N}_{2}}{{N}_{0}} .$$

For the example system,
tan ψ_{1,2}≦1.5.

For point 3, we have;

$$\begin{matrix}d = \frac{( 1 + 2 m ) λ}{4 \sqrt{{N}_{1}^{2} - {N}_{0}^{2} {sin}^{2} {ϕ}_{0}}} , & ( 46 ) \\ tan {ψ}_{3} = \frac{{N}_{0} {N}_{2} cos {ϕ}_{0} cos {ϕ}_{2} + {N}_{1}^{2} {cos }^{2} {ϕ}_{1}}{{N}_{0} {N}_{2} {cos}^{2} {ϕ}_{1} + {N}_{1}^{2} cos {ϕ}_{0} cos {ϕ}_{2}} , & ( 47 ) \\ ( {ϕ}_{01} , {ϕ}_{02} ) = ( \begin{matrix}{sin}^{- 1} \sqrt{\frac{- {D}_{17} + \sqrt{{D}_{17}^{2} - 4 {D}_{16} {D}_{18}}}{2 {D}_{16}}} , \\ {sin}^{- 1} \sqrt{\frac{- {D}_{17} + \sqrt{{D}_{17}^{2} - 4 {D}_{16} {D}_{18}}}{2 {D}_{16}}}\end{matrix} ) , & ( 48 ) \\ ( {D}_{16} , {D}_{17} , {D}_{18} , {N}_{17} ) = ( \begin{matrix}\begin{matrix}{N}_{0}^{2} ( {N}_{17} {N}_{0}^{2} - 1 ) , {N}_{2}^{2} + \\ {N}_{0}^{2} ( 1 - 2 {N}_{17} {N}_{1}^{2} ) , {N}_{17} {N}_{1}^{4} -\end{matrix} \\ {N}_{2}^{2} , \frac{{{N}_{2}^{2} ( tan ψ {N}_{7} - 1 )}^{2}}{{{N}_{1}^{4} ( {N}_{7} - tan ψ )}^{2}}\end{matrix} ) . & ( 49 )\end{matrix}$$

For a given system,

$$tan {ψ}_{3} \leq \frac{{N}_{1}^{2}}{{N}_{0} {N}_{2}} ,$$

depending on the angle of incidence, and it is equal at grazing incidence. For the example system, tan ψ₃≦1.2696.

Note that the relative amplitude attenuation for point 3 is less than that for points 1 and 2 for the same angle of incidence. That provides for a choice of higher or lower angles of incidence for the designs under consideration, which in turn provides for a choice of a lower or higher transmittance, respectively. This is in addition to the choice of the associated film thickness.

Equations (48) give two angles of incidence; if one of them is complex then it is the one to reject. If a value of

$$tan {ψ}_{3} > \frac{{N}_{1}^{2}}{{N}_{0} {N}_{2}}$$

is introduced into Eqs. (48) and (49), the obtained real angle of incidence gives a different τ than the required. For example, if we start with tan ψ=1.4, and use Eq. (48) to find the angle of incidence, we get φ₀=83.8149°. Equation (46) gives a reduced film thickness of 1652.9 nm. TEF for those values are 1.185which is different from our starting value of 1.4. Accordingly, that is not a solution. With a close look at the solution, one clearly sees that the solution obtained is for point 1 and not 3. If a starting value greater than N₂/N₀ is used, for example tan ψ=11.2, the obtained angle of incidence of 54.2453° and reduced film thickness of 1417.4 give a wrong value of τ=1.0343.

It is also possible to use the design equations for the general case with the proper choice of Δ=0° and the required value of

$$1 \leq tan ψ < \frac{{N}_{2}}{{N}_{0}} ,$$

as limited by Eq. (35). There are an infinite number of LPP designs achievable with the positive system within that limit. Therefore, the LPP design is obtained by substituting the values of choice into the general design equations, Eqs. (36) and (24). If there is no operating angle of incidence or film thickness preference, then the design of a larger transmittance is the one to use; designs at lower angles of incidence.

In all cases, a check of real film thickness, of
|X|=1,
and of the required value of τ leads to rejecting the wrong solution(s), if exist(s).
Negative Film-Substrate System

In this section, we present design-specific closed-form formulae for all the feasible TPDs using a negative film-substrate system. The reader is spared the algebraic derivation of these closed-form formulae.

Transmission Retarders

The design equations for a TR are;

$$\begin{matrix}( {ϕ}_{01 TR} , {ϕ}_{02 TR} , {ϕ}_{03 TR} ) = ( \begin{matrix}{sin}^{- 1} \sqrt{{N}_{14} - \frac{{N}_{11}}{3 {N}_{14}} - \frac{{D}_{13}}{3 } ,} \\ {sin}^{- 1} \sqrt{{N}_{15} - \frac{{N}_{11}}{3 {N}_{15}} - \frac{{D}_{13}}{3 } ,} \\ {sin}^{- 1} \sqrt{{N}_{16} - \frac{{N}_{11}}{3 {N}_{16}} - \frac{{D}_{13}}{3 } ,}\end{matrix} ) & ( 50 ) \\ ( {N}_{11} , {N}_{12} , {N}_{13} ) = ( \begin{matrix}{D}_{14} - \frac{{D}_{13}^{2}}{3} , - {D}_{15} - \frac{{D}_{13} {D}_{14}}{3} + \\ \frac{2 {D}_{13}^{3}}{27} , - \frac{{N}_{12}}{2} + \sqrt{\frac{{N}_{12}^{2}}{4} + \frac{{N}_{11}^{3}}{27}}\end{matrix} ) , & ( 50. a ) \\ ( {N}_{14} , {N}_{15} , {N}_{16} ) = ( \sqrt[3]{{N}_{13}} , {ⅇ}^{j \frac{}{1.5}} {N}_{14} , {ⅇ}^{j \frac{}{1.5}} {N}_{15} ) , & ( 50. b ) \\ ( {D}_{12} , {D}_{13} , {D}_{14 ,} {D}_{15} ) = ( {M}_{3}^{3} ( {N}_{2}^{2} - {N}_{0}^{2} ) , \frac{{D}_{10}}{{D}_{9}} , \frac{{D}_{11}}{{D}_{9}} , - \frac{{D}_{12}}{{D}_{9}} ) , & ( 50. c ) \\ {D}_{11} = 2 {M}_{3} {M}_{4} ( {N}_{2}^{2} - {N}_{0}^{2} ) + {M}_{3}^{2} {N}_{0}^{2} - {M}_{1}^{2} {N}_{2}^{2} , & ( 50. d ) \\ ( {D}_{9} , {D}_{10} ) = ( \begin{matrix}{M}_{4}^{2} {N}_{0}^{2} - {M}_{2}^{2} {N}_{2}^{2} , {M}_{4}^{2} ( {N}_{2}^{2} - {N}_{0}^{2} ) + \\ 2 {M}_{3} {M}_{4} {N}_{0}^{2} + 2 {M}_{1} {M}_{2} {N}_{2}^{2}\end{matrix} ) , & ( 50. e ) \\ ( {M}_{3} , {M}_{4} ) = ( {K}_{3} ( {N}_{1}^{2} - {N}_{0}^{2} ) {N}_{2}^{2} , ( {K}_{2} {N}_{1}^{2} + {K}_{3} {N}_{0}^{2} ) {N}_{2}^{2} ) , & ( 50. f ) \\ ( {M}_{1} , {M}_{2} ) = ( \begin{matrix}( {K}_{1} {N}_{2}^{2} + {K}_{4} {N}_{1}^{2} ) {N}_{0}^{2} - 2 ( {K}_{1} + {K}_{4} ) {N}_{1}^{2} {N}_{2}^{2} , \\ ( {K}_{1} {N}_{2}^{2} + {K}_{4} {N}_{1}^{2} ) {N}_{0}^{2}\end{matrix} ) , & ( 50. g ) \\ ( {K}_{3} , {K}_{4} ) = ( cos β ( 1 + {N}_{7} {N}_{8} ) - {N}_{8} , cos β ( {N}_{7} + {N}_{8} ) - {N}_{7} {N}_{8} ) , & ( 50. h ) \\ ( {K}_{1} , {K}_{2} ) = ( cos β ( {N}_{7} + {N}_{8} ) - 1 , cos β ( 1 + {N}_{7} {N}_{8} ) - {N}_{7} ) , & ( 50. i ) \\ ( {N}_{7} , {N}_{8} ) = ( \frac{{N}_{0} {N}_{2}}{{N}_{1}^{2}} , \frac{{N}_{2}}{{N}_{0}} ) . & ( 50. j )\end{matrix}$$

The film thickness is given by;

$$\begin{matrix}d = \frac{- λ}{4 π \sqrt{{N}_{1}^{2} - {N}_{0}^{2} {sin}^{2} {ϕ}_{0}}} [ arg ( X ) - 2 π m ] , m = 0 , 1 , 2 , … , & ( 51 ) \\ X = \frac{A τ - 1}{B - A C τ} . & ( 51. a )\end{matrix}$$

The following algorithm gives a step-by-step methodology to design the TR;

Algorithm 1

(1) Select the film and substrate materials to work with, and the wavelength of operation.

(2) Obtain the optical constants (in this case only the refractive indices for the transparent film and the transparent substrate).

(3) Select the design value of the relative phase shift β.

(4) Calculate the angle of incidence of operation φ₀and the film thickness dusing Eqs. (50) and (51). Note that the complex values obtained for the angle of incidence are to be ignored.

Linear Partial Polarizers

At every angle of incidence, there exist two possible LPPs, LPP1 and LPP2 where α_{LPP1}<α_{LPP2}. The design equations for an LPP1 are;

$$\begin{matrix}{d}_{LPP 1} = \frac{( 1 + 2 m ) λ}{4 \sqrt{{N}_{1}^{2} - {N}_{0}^{2} {sin}^{2} {ϕ}_{0}}} , m = 0 , 1 , 2 , … , & ( 52 ) \\ ( {ϕ}_{01 LPP 1} , {ϕ}_{02 LPP 1} ) = ( \begin{matrix}{sin}^{- 1} \sqrt{\frac{- {D}_{1} + \sqrt{{D}_{1}^{2} - 4 {D}_{0} {D}_{2}}}{2 {D}_{0}}} , \\ {sin}^{- 1} \sqrt{\frac{- {D}_{1} - \sqrt{{D}_{1}^{2} - 4 {D}_{0} {D}_{2}}}{2 {D}_{0}}}\end{matrix} ) , & ( 53 ) \\ ( {D}_{0} , {D}_{1} , {D}_{2} ) = ( \begin{matrix}{N}_{0}^{2} ( {NN}_{0}^{2} - 1 ) , \\ {N}_{2}^{2} + {N}_{0}^{2} ( 1 - 2 {NN}_{1}^{2} ) , \\ {NN}_{1}^{4} - {N}_{2}^{2}\end{matrix} ) , & ( 54. a ) \\ ( N , {N}_{3} ) = ( \frac{{{N}_{2}^{2} ( {α}_{LLPS} {N}_{3} - 1 )}^{2}}{{{N}_{1}^{4} ( {N}_{3} - {α}_{LPPS} )}^{2}} , \frac{{N}_{0} {N}_{2}}{{N}_{1}^{2}} ) . & ( 54. b )\end{matrix}$$

The design equations for an LPPL are;

$$\begin{matrix}{d}_{LLP 2} = \frac{m λ}{2 \sqrt{{N}_{1}^{2} - {N}_{0}^{2} {sin}^{2} {ϕ}_{0}}} , m = 1 , 2 , … , & ( 55 ) \\ {ϕ}_{0 LPP 2} = {sin}^{- 1} \sqrt{\frac{{N}_{2}^{2} ( {α}^{2} - 1 ) ( {N}_{2}^{2} - {N}_{0}^{2} )}{{{N}_{2}^{2} ( α {N}_{2} + {N}_{0} )}^{2} - {{N}_{0}^{2} ( {N}_{2} - α {N}_{0} )}^{2}}} . & ( 56 )\end{matrix}$$

The following algorithm gives a step-by-step methodology to design an LPP;

Algorithm 2

(1) Select the film and substrate materials to work with, and the wavelength of operation.

(2) Obtain the optical constants (in this case only the refractive indices).

(3) Select the design value of the relative amplitude attenuation α.

(4) Calculate the film thickness dand the angle of incidence of operation φ₀using Eqs. (52) and (53) for an LPP1 and Eqs. (55) and (56) for an LPP2.

General Device

The design equations for a GPD are;

$$\begin{matrix}( {ϕ}_{0 GPD} , {ϕ}_{02 GPD} , {ϕ}_{03 GPD} ) = ( \begin{matrix}{sin}^{- 1} \sqrt{{N}_{14} - \frac{{N}_{11}}{3 {N}_{14}} - \frac{{D}_{13}}{3}} , \\ {sin}^{- 1} \sqrt{{N}_{15} - \frac{{N}_{11}}{3 {N}_{15}} - \frac{{D}_{13}}{3}} , \\ {sin}^{- 1} \sqrt{{N}_{16} - \frac{{N}_{11}}{3 {N}_{16}} - \frac{{D}_{13}}{3}}\end{matrix} ) , & ( 57 ) \\ ( {N}_{11} , {N}_{12} , {N}_{13} ) = ( \begin{matrix}{D}_{14} - \frac{{D}_{13}^{2}}{3} , \\ - {D}_{15} - \frac{{D}_{13} {D}_{14}}{3} + \frac{2 {D}_{13}^{3}}{27} , \\ - \frac{{N}_{12}}{2} + \sqrt{\frac{{N}_{12}^{2}}{4} + \frac{{N}_{11}^{3}}{27}}\end{matrix} ) , & ( 58 ) \\ ( {N}_{14} , {N}_{15} , {N}_{16} ) = ( \sqrt[3]{{N}_{13}} , {ⅇ}^{j \frac{π}{1.5}} {N}_{14} , {ⅇ}^{j \frac{π}{1.5}} {N}_{15} ) , & ( 59. a ) \\ ( {D}_{12} , {D}_{13} , {D}_{14} , {D}_{15} ) = ( ( {D}_{6}^{2} - {D}_{8}^{2} ) {N}_{2}^{2} , \frac{{D}_{10}}{{D}_{9}} , \frac{{D}_{11}}{{D}_{9}} , - \frac{{D}_{12}}{{D}_{9}} ) , & ( 59. b ) \\ {D}_{11} = ( {D}_{8}^{2} + 2 {D}_{7} {D}_{8} - 2 {D}_{5} {D}_{6} ) {N}_{2}^{2} - {D}_{6}^{2} {N}_{0}^{2} , & ( 59. c ) \\ ( {D}_{9} , {D}_{10} ) = ( \begin{matrix}{D}_{7}^{2} {N}_{2}^{2} - {D}_{5}^{2} {N}_{0}^{2} , \\ ( {D}_{5}^{2} - {D}_{7}^{2} - 2 {D}_{5} {D}_{8} ) {N}_{2}^{2} + \\ 2 {D}_{5} {D}_{6} {N}_{0}^{2}\end{matrix} ) , & ( 59. d ) \\ ( {D}_{7} , {D}_{8} ) = ( ( {D}_{1} {N}_{2}^{2} + {D}_{4} {N}_{1}^{2} ) {N}_{0}^{2} , ( {D}_{1} + {D}_{4} ) {N}_{1}^{2} {N}_{2}^{2} ) , & ( 59. e ) \\ ( {D}_{5} , {D}_{6} ) = ( ( {D}_{3} {N}_{0}^{2} + {D}_{2} {N}_{1}^{2} ) {N}_{2}^{2} , ( {D}_{2} + {D}_{3} ) {N}_{1}^{2} {N}_{2}^{2} ) , & ( 59. f ) \\ ( {D}_{3} , {D}_{4} ) = ( \begin{matrix}α ( α {N}_{3} - cos β ( 1 + {N}_{3} {N}_{4} ) ) + {N}_{4} , \\ α ( α - cos β ( {N}_{3} + {N}_{4} ) ) + {N}_{3} {N}_{4}\end{matrix} ) , & ( 59. g ) \\ ( {D}_{1} , {D}_{2} ) = ( \begin{matrix}α ( α {N}_{3} {N}_{4} - cos β ( {N}_{3} + {N}_{4} ) ) + 1 , \\ α ( α {N}_{4} - cos β ( 1 + {N}_{3} {N}_{4} ) ) + {N}_{3}\end{matrix} ) , & ( 59. h ) \\ ( {N}_{3} , {N}_{4} ) = ( \frac{{N}_{0} {N}_{2}}{{N}_{1}^{2}} , \frac{{N}_{2}}{{N}_{0}} ) . & ( 59. i )\end{matrix}$$

The film thickness is obtained by;

$$\begin{matrix}d = \frac{- λ}{4 π \sqrt{{N}_{1}^{2} - {N}_{0}^{2} {sin}^{2} {ϕ}_{0}}} [ arg ( X ) - 2 π m ] , m = 0 , 1 , 2 , … , & ( 60 ) \\ X = \frac{A τ - 1}{B - A C τ} . & ( 61 )\end{matrix}$$

A, B, and C are given by Eqs. (5).

The following algorithm gives a step-by-step methodology to design a GPD;

Algorithm 3

(1) Select the film and substrate materials to work with, and the wavelength of operation.

(2) Obtain the optical constants (in this case only the refractive indices).

(3) Select the design value of the relative amplitude attenuation α and that of the relative phase shift β.

(4) Calculate the angle of incidence of operation φ₀and the film thickness d using Eqs. (57) and (60). Note that the complex values obtained for the angle of incidence are to be ignored.

Thin-Film Coatings

Transmission thin-film coatings behave polarization-wise exactly as TPDs. They are governed by the same controlling equation, Eq. (1). Therefore, they are designed the same way. Accordingly, the analyses and closed-form design formulae discussed and presented above hold equally to thin-film coatings.

Substrate Considerations

The substrate considerations to employ the transmitted beam from a film-substrate system and Eqs. (1)-(7) are well established in the literature. For example, as early as 1975, a comprehensive treatment of the design of the substrate and the conditions to satisfy is detailed in Ref. 25. As recent as this year, 2005, a substrate prizm is employed to provide the transmitted wave for use. During this period of 30 years, numerous publications used the special substrate design(s) for precisely the same purpose, to provide the transmitted beam for use and to apply Eqs. (1)-(7). Some even used a double prizm. Some discussed the substrate considerations and some considered that to be stating the obvious.

For Eqs. (1)-(7) to apply to the transmitted beam from a film-substrate system, the bottom surface of the substrate, with respect to the incident beam, should be perpendicular to that transmitted beam. This allows for that beam to pass through the substrate into the ambient with no change in any of the ellipsometric parameters. This is achieved by use of a prizm for constant angle of incidence applications, and by a hemisphere, or semicylinder, for variable angle of incidence applications.

For the design of polarization devices, a prizm is sufficient unless the device is an angle-of-incidence tunable one. In that case, one of the other two designs is sufficient. With today's manufacturing capabilities, precise miniature devices made of any of the three substrate designs is easy to produce.

### APPLICATIONS

There exist an almost unlimited number of applications using transparent thin-film coatings and devices in the transmission mode. It is used for beam steering and control, amplification, waveguide structures, projectors, antireflection coatings, etc. We only discuss in this section an interesting industrial application; transmission ellipsometric memory for CDs and DVDs.

Transmission ellipsometric memory has an important advantage over the reflection type. It requires much less surface area, and the beam is readily available on the other side of the optical structure, and not through oblique reflection. The optical structure is composed of a saw-tooth grating-surface of a transparent substrate, glass or polymer, and overlaid multi-film layers. The number of proposed layers is 4to represent digitally a 15 digit decimal number. The order of the multi-film layers determines the corresponding digital sequence. A laser beam shines vertically on the structure, and the angle of incidence is determined by the tooth angle.

We propose a single-layer film-substrate system to replace the 4-layer system. The film-thickness itself replaces the number of layers. Therefore, any number of film thicknesses are to be used, and not necessarily 4. Accordingly, the tooth is covered by the required film thickness to represent the 0 or 1, in addition to its place in the mantissa.

Practical considerations of material choice, film thicknesses choice, angle of incidence, and ψ and Δ separation between digits are easily addressed and manipulated using the CAICs and CTCs, the design methodology discussed in the previous sections, and the design formulae of Eqs. (36) and (22)-(24).

### CONCLUSIONS

The transmission ellipsometric function TEF is presented as two successive transformations. Its behavior is analyzed as the angle of incidence and film thickness, of the film-substrate system, are changed. The constant-angle-of-incidence contours (CAICs) and constant-thickness contours (CTCs) are used to comprehensively understand and utilize that behavior. From the discussed analysis and understanding of the behavior of TEF, and from the definition of a polarization device as a film-substrate system that introduces prescribed polarization changes, the design of all existing types of devices are discussed. Device-specific formulae, for all types of devices, are presented. In addition, a general formula that is used for the design of any polarization device is also presented. In this communication, thin film coatings are treated as polarization devices. A brief discussion of suggested practical modifications to, and simplifications of, an interesting application of polarization devices; ellipsometric memory, concludes the presentation.

What is claimed is:

1. A methodology to design any and all smart transmission polarization-devices and smart thin-film coatings using one general closed-form design formula, where smart-device-specific closed-form design formulae are special cases thereof and where the unsupported film/pellicle and bare substrate are special cases thereof.

2. A methodology to design a smart transmission ellipsometric memory system using the same general closed-form design formula of claim 1.

3. A “Smart Ellipsometer” utilizing the same general closed-form design formula (in a modified form) in data reduction of ellipsometric measurements on any film-substrate system in the transmission mode, specifically the general device design equation with any and all ellipsometric techniques; the Linear Partial Polarizer design equation for any ellipsometric technique detecting that condition, and the Transmission Retarder design equation for any ellipsometric technique detecting that condition and specifically Single-Element-Rotating-Polarizer ellipsometers; and for any and all ellipsometric techniques doing transmission measurements on any and all film-substrate systems in the general case including bare substrates and unsupported films/pellicles.

4. Computer programs and hardware implementations of claims 1 through 3.
